(19) United States
(12) Patent Application Publication
(10) Pub. No.: US 2022/0009027 A1
(43) Pub. Date: Jan. 13, 2022

(54) STEP-CORE FIBER STRUCTURES AND METHODS FOR ALTERING BEAM SHAPE AND INTENSITY

(71) Applicant: PANASONIC INTELLECTUAL PROPERTY MANAGEMENT CO. LTD, Osaka (JP)

(72) Inventors: Wang-Long ZHOU, Andover, MA (US); Francisco VILLARREAL-SAUCEDO, Middleton, MA (US); Bien CHANN, Merrimack, NH (US)

(21) Appl. No.: 17/363,171

(22) Filed: Jun. 30, 2021

Related U.S. Application Data
(60) Provisional application No. 63/048,714, filed on Jul. 7, 2020.
(60) Provisional application No. 63/060,801, filed on Aug. 4, 2020.

(51) Int. Cl. B23K 26/064; G02B 6/26; B23K 26/08; B23K 26/06

(52) U.S. Cl. CPC B23K 26/064; B23K 26/0604; B23K 26/08; G02B 6/262

(57) ABSTRACT

In various embodiments, a workpiece is processed utilizing one or more output beams emitted from a step-core optical fiber and formed from one or more input beams that may have non-circular beam shapes. In various embodiments, an input beam may be a variable-power laser beam having a laser-beam numerical aperture (NA) that varies as a function of the power of the laser beam. The step-core optical fiber may have an outer core NA that is greater than or equal to the laser-beam NA at a laser power of approximately 100%, an inner core NA that is less than or equal to the outer core NA, and an inner core NA that is greater than or equal to the laser-beam NA at a power of 50%.

### RELATED APPLICATIONS

This application claims the benefit of and priority to U.S. Provisional Patent Application No. 63/048,714, filed Jul. 7, 2020, and U.S. Provisional Patent Application No. 63/060,801, filed Aug. 4, 2020, the entire disclosure of each of which is hereby incorporated herein by reference.

### TECHNICAL FIELD

In various embodiments, the present invention relates to laser systems and optical fibers, specifically laser systems and optical fibers enabling control of beam intensity and beam parameters such as beam parameter product.

### BACKGROUND

High-power laser systems are utilized for a host of different applications, such as welding, cutting, drilling, and materials processing. Such laser systems typically include a laser emitter, the laser light from which is coupled into an optical fiber (or simply a “fiber”), and an optical system that focuses the laser light from the fiber onto the workpiece to be processed. The optical system is typically engineered to produce the highest-quality laser beam, or, equivalently, the beam with the lowest beam parameter product (BPP). The BPP is the product of the laser beam's divergence angle (half-angle) and the radius of the beam at its narrowest point (i.e., the beam waist, the minimum spot size). That is, BPP=NA×D/2, where D is the focusing spot (the waist) diameter and NA is the numerical aperture; thus, the BPP may be varied by varying NA and/or D. The BPP quantifies the quality of the laser beam and how well it can be focused to a small spot, and is typically expressed in units of millimeter-milliradians (mm-mrad). A Gaussian beam has the lowest possible BPP, given by the wavelength of the laser light divided by pi. The ratio of the BPP of an actual beam to that of an ideal Gaussian beam at the same wavelength is denoted M², which is a wavelength-independent measure of beam quality.

High-power industrial lasers are typically delivered by conventional multi-mode step-index fibers. In such systems, the BPP at the output is usually substantially larger than the BPP at the input, a BPP-degradation effect mainly caused by the shape and/or size mismatch of the input laser spot with the fiber center core. In addition, for a given total beam power, higher peak intensity and smaller effective laser spot on the workpiece are beneficial to many applications, such as sheet metal cutting and drilling. Thus, there is a need for optical-fiber structures, systems, and techniques that address coupling-related degradation of BPP while also enabling the production of small output beam size and concomitant high beam intensity for various applications.

### SUMMARY

Various embodiments of the present invention provide laser systems, coupling and delivery techniques, and optical fibers that enable efficient beam coupling and delivery, with minimal BPP degradation, even when the input beam shape varies. In addition, optical fibers in accordance with embodiments of the invention may be utilized to generate effectively smaller output spot sizes and substantially larger peak beam intensities without the use of smaller fibers. In this manner, embodiments of the invention generate output beams without sacrificing fiber-coupling efficiency and beam stability.

Embodiments of the invention include and utilize optical fibers referred to herein as “step-core” fibers. Conventional laser-delivery systems, particularly those for industrial processing, utilize conventional step-index optical fibers having a single central core and a single outer cladding surrounding the core. In contrast, step-core fibers in accordance with embodiments of the present invention include, consist essentially of, or consist of an inner core, and outer annular core surrounding the inner core, and a cladding surrounding the outer core. In various embodiments, the outer core is disposed between and directly contacts, on opposite surfaces, the inner core and the cladding. In various embodiments, the step-core fiber may include one or more core, coating, and/or cladding layers disposed outside of the cladding layer. Such layers may be provided for various purposes, including but not limited to BPP manipulation, fiber structural support, fiber protection, etc. Thus, while the inner core, outer core and cladding layers typically include, consist essentially of, or consist of glass, e.g., fused silica or doped fused silica, layers disposed outside of the cladding layer may include, consist essentially of, or consist of glass (e.g., fused silica, doped fused silica), a polymer, plastic, etc. Various embodiments of the invention do not incorporate mode strippers in or on the optical fiber structure. Similarly, the various layers of optical fibers in accordance with embodiments of the invention are continuous along the entire length of the fiber and do not contain holes, photonic-crystal structures, breaks, gaps, or other discontinuities therein.

Step-core optical fibers in accordance with the invention may be multi-mode fibers and therefore support multiple modes therein (e.g., more than three, more than ten, more than 20, more than 50, or more than 100 modes). In addition, step-core fibers in accordance with the invention are generally passive fibers, i.e., are not doped with active dopants (e.g., erbium, ytterbium, thulium, neodymium, dysprosium, praseodymium, holmium, or other rare-earth metals) as are typically utilized for pumped fiber lasers and amplifiers. Rather, dopants utilized to select desired refractive indices in various layers of fibers in accordance with the present invention are generally passive dopants that are not excited by laser light, e.g., fluorine, titanium, germanium, and/or boron. Obtaining a desired refractive index for a particular layer or region of an optical fiber in accordance with embodiments of the invention may be accomplished (by techniques such as doping) by one of skill in the art without undue experimentation. Relatedly, optical fibers in accordance with embodiments of the invention may not incorporate reflectors or partial reflectors (e.g., grating such as Bragg gratings) therein or thereon. Fibers in accordance with embodiments of the invention are typically not pumped with pump light configured to generate laser light of a different wavelength. Rather, fibers in accordance with embodiments of the invention merely propagate light along their lengths without changing its wavelength.

In addition, step-core fibers and systems in accordance with embodiments of the present invention are typically utilized for materials processing (e.g., cutting, drilling, etc.), rather than for applications such as optical communication or optical data transmission. Thus, laser beams coupled into fibers in accordance with embodiments of the invention typically have wavelengths less than the 1.3 μm or 1.5 μm utilized for optical communication. In fact, fibers utilized in accordance with embodiments of the present invention may exhibit dispersion at one or more (or even all) wavelengths in the range of approximately 1260 nm to approximately 1675 nm utilized for optical communication. For example, laser wavelengths utilized in accordance with embodiments of the invention may have wavelengths ranging from approximately 780 nm to approximately 1064 nm, from approximately 780 nm to approximately 1000 nm, from approximately 870 nm to approximately 1064 nm, or from approximately 870 nm to approximately 1000 nm. In various embodiments, the wavelength (or primary or center wavelength) of the laser beam may be, for example, approximately 1064 nm, approximately 970 nm, approximately 780 or 850 to approximately 1060 nm, or approximately 950 nm to approximately 1070 nm. In various embodiments, the laser wavelength may be far greater than those wavelengths utilized for optical communication (e.g., approximately 1260 nm to approximately 1675 nm), e.g., ranging from approximately 2 μm to approximately 11 μm, or from approximately 5 μm to approximately 11 μm.

In various embodiments, the laser beam has a wavelength (or range of wavelengths) in the high-energy visible (e.g., blue, green, or violet) or ultraviolet (UV) range. For example, the wavelength may range from approximately 300 nm to approximately 740 nm, approximately 400 nm to approximately 740 nm, approximately 530 nm to approximately 740 nm, approximately 300 nm to approximately 810 nm, approximately 400 nm to approximately 810 nm, or approximately 530 nm to approximately 810 nm. In various embodiments, the wavelength of the laser beam is in the UV or visible range, although the wavelength may extend up to approximately 810 nm for various applications. In particular embodiments, the wavelength (or primary or center wavelength) of the laser beam may be, for example, approximately 810 nm, approximately 400-approximately 460 nm, or approximately 532 nm. (Herein, it is understood that references to different “wavelengths” encompass different “ranges of wavelengths” or different “primary wavelengths.”)

In accordance with additional embodiments of the invention, two or more laser beams, each having a different wavelength, are coupled into the step-core fiber, serially and/or simultaneously, to harness advantages of each wavelength for the optimization of materials processing. Such embodiments may incorporate details and techniques described in U.S. patent application Ser. No. 16/984,489, filed on Aug. 4, 2020, the entire disclosure of which is incorporated by reference herein. For example, in various embodiments, a laser system features a primary laser emitting at a relatively longer wavelength (e.g., infrared or near-infrared) utilized for cutting materials (e.g., metallic materials), as well as a secondary laser emitting at a relatively shorter wavelength (e.g., ultraviolet or visible) utilized at least for initial piercing operations at the initiation of cutting. In general, various metals exhibit greater absorption of laser light at shorter wavelengths, at least in the solid state. Thus, shorter-wavelength lasers may be efficiently utilized for piercing operations performed at, for example, the initiation of laser cutting. That is, piercing operations may be performed more quickly, and with higher quality (e.g., edge roughness) with shorter-wavelength lasers. Unfortunately, many short-wavelength lasers (e.g., lasers emitting in the green or blue wavelength range) are less efficient, have shorter lifetimes, are more expensive, and ramp to full power more slowly and/or less easily than various longer-wavelength lasers, such as near-infrared lasers. In addition, once metals are molten, their absorbance of laser light becomes less dependent on, or even independent of, the laser wavelength. Thus, actual cutting operations, once metals are pierced and molten, may be more quickly and efficiently performed by longer-wavelength lasers, which generally have longer lifetimes and exhibit higher efficiency. Such longer-wavelength lasers may be unsuitable for the initial piercing operation, due to (1) lower absorption of the longer wavelengths by the material and/or (2) high reflectivity of the longer wavelengths by the material, which can not only prevent initiation of laser cutting but also lead to damage of the laser system (or various components thereof) by spurious reflections.

In an example cutting operation, a laser is emitted toward the surface of the material, whereupon at least a portion of the laser energy is absorbed, thereby heating the material. After sufficient energy absorption, the surface of the material melts and becomes molten. Thereafter, the sub-surface material also melts, generating a hole in the material. Once such a hole is formed, laser energy may be translated across the material, cutting through the material in a desired pattern. In accordance with various embodiments of the invention, a secondary, smaller-wavelength laser is utilized to initiate a cutting operation. In various embodiments, the secondary laser emits light onto the surface of the material to be processed at least until a portion of the surface of the material is molten. (That is, the secondary laser need not be utilized until the hole is actually generated through the material, so long as at least some of the material is molten and therefore more absorptive to laser light of longer wavelengths; however, in various embodiments, the secondary laser is utilized at least until a hole forms through the material.) After at least a portion of the material surface is molten, the primary laser emits longer-wavelength light onto the material at substantially the same point (i.e., the primary and secondary laser beams may be coaxial, since they are coupled into the same step-core optical fiber) and then translated across the material to produce a cut. Thus, in various embodiments, the secondary laser may be utilized at a lower power and/or for less time, extending its lifetime. Moreover, the use of the secondary laser enables the efficient processing of materials that are highly reflective to longer laser wavelengths (e.g., infrared or near-infrared), such as copper.

In various embodiments, the secondary laser may be utilized (i.e., may emit laser energy toward the material) not only for piercing of the material (e.g., when initiating a cutting operation), but also during the cutting operation if one or more properties of the material change or if it is desired to alter one or more properties of the cut itself. For example, if the thickness of the material changes (e.g., increases) at one or more points, the secondary laser may be utilized at such points to efficiently continue the cutting operation. In addition, the secondary laser may be utilized (with or without the primary laser) at a point where it is desired to alter (e.g., increase) the size of the cut, and/or at a point where the cutting direction changes.

As detailed above, the primary and secondary lasers may be utilized independently of each other during different portions of the piercing/cutting operation (or other processing operation). That is, the secondary laser may be utilized to initiate the cut and then turned off, whereupon the primary laser may be powered on to complete the operation, and the two lasers do not emit light toward the material simultaneously. However, in various embodiments, both lasers are coupled into the step-core fiber, and therefore emit light toward the material, simultaneously for at least a portion of the processing operation. That is, the step-core fiber may emit light from both lasers toward the surface during at least a portion of the piercing operation and/or during at least a portion of the subsequent cutting operation. The simultaneous use of both lasers may provide extra laser power, thereby enabling faster cutting and/or the cutting of thicker materials. In addition, the extended bandwidth provided by simultaneous use of both lasers may improve the surface quality of the processed/cut material via increases scrambling of laser coherence and speckle. In various embodiments, both lasers emit light toward the material simultaneously, but the power of one or the other is modulated during one or more portions of the process. For example, during piercing the primary laser may emit light but at a lower power than during the subsequent cutting operation. Similarly, the secondary laser may emit light during cutting, but at a lower power than during the initial piercing operation.

In various embodiments, the operation of the primary and secondary lasers, and therefore the in-coupling of the lasers into the step-core fiber, is controlled by a computer-based controller. In embodiments in which the primary laser is used (or primarily used) for cutting after the secondary laser is used (or primarily used) for piercing, the controller may power on the primary laser (or ramp up its power level) at a desired point in the process (e.g., when at least a portion of the material surface is molten but before a hole is formed in the material, or even after the hole forms in the material). At such time, the controller may power off the secondary laser (or ramp down its power level). The controller may initiate this use of the primary laser directly in response to the state of the material surface (e.g., when it becomes molten). For example, the laser system may include one or more sensors that monitor the material surface and detect when it is molten via changes in, for example, reflectivity and/or temperature of the surface. (As known to those of skill in the art, when a surface becomes molten, this phase change may be accompanied by an abrupt change in reflectivity (e.g., to longer wavelengths such as infrared or near-infrared wavelengths). The temperature rise of the surface of the material may also slow, at least until the material begins to vaporize.) In other embodiments, the controller may simply initiate the use of the primary laser (and/or power down or off the secondary laser) after a timed delay.

Thus, in various embodiments, a secondary, shorter wavelength laser is utilized (or primarily utilized) to melt, pierce, or partially pierce a material and, thereafter, a primary, longer wavelength laser is utilized (or primarily utilized) to cut the material (e.g., via translation of the primary laser spot across the material). In general, the secondary laser may be utilized to initiate a particular process, while the primary laser may be utilized to complete the process after it is initiated. While such embodiments may be particularly suited to metallic materials, in various embodiments the longer wavelength laser is utilized (or primarily utilized) to melt, pierce, or partially pierce a material and, thereafter, the shorter wavelength laser is utilized (or primarily utilized) to cut the material (e.g., via translation of the primary laser spot across the material). For example, many non-metallic materials such as glasses and plastics are transparent at visible and near-IR wavelengths, but may exhibit high absorption at UV wavelengths (e.g., less than approximately 350 nm) and/or IR wavelengths (e.g., ranging from approximately 2 μm to approximately 11 μm). Thus, while such materials may be processed as detailed above and herein, i.e., with the shorter wavelength laser for piercing and/or melting, and the longer wavelength laser for cutting, the laser wavelengths may be selected so that such materials may be processed with the longer wavelength laser used for piercing and/or melting, and the shorter wavelength laser used for cutting. Thus, for such materials, the “secondary laser” as described herein may have a longer wavelength than the “primary laser” in various embodiments. (For example, a primary laser may have a near-IR wavelength while the secondary laser may have a wavelength of approximately 5 μm (e.g., a CO laser) or approximately 10.6 μm (e.g., a CO₂ laser)).

In accordance with various embodiments of the invention, both the primary laser and the secondary laser may be coupled into the step-core fiber by the same focusing optics. For example, a dichroic mirror or other optical element(s) may be utilized to direct the two lasers, such that they are approximately coaxial, to a focusing lens that couples the laser beams into the step-core fiber. In various embodiments, the secondary laser (i.e., the laser having the shorter wavelength) is focused to a smaller spot size and coupled into the inner core of the step-core fiber, and the primary laser (i.e., the laser having the longer wavelength) is focused to a larger spot size and coupled into both the inner core and the outer, annular core of the step-core fiber. In this manner, the use of shared focusing optics is enabled without sacrificing output beam quality or in-coupling efficiency, even though the spot size of the primary laser may be larger (at least in one dimension) than the diameter of the inner core of the step-core fiber.

Herein, “optical elements” may refer to any of lenses, mirrors, prisms, gratings, and the like, which redirect, reflect, bend, or in any other manner optically manipulate electromagnetic radiation, unless otherwise indicated. Herein, beam emitters, emitters, or laser emitters, or lasers include any electromagnetic beam-generating device such as semiconductor elements, which generate an electromagnetic beam, but may or may not be self-resonating. These also include fiber lasers, disk lasers, non-solid state lasers, etc. An emitter may include or consist essentially of multiple beam emitters such as a diode bar configured to emit multiple beams. The input beams received in the embodiments herein may be single-wavelength or multi-wavelength beams combined using various techniques known in the art. The output beams produced in embodiments of the invention may be single-wavelength or multi-wavelength beams.

Embodiments of the invention may be utilized with wavelength beam combining (WBC) systems that include a plurality of emitters, such as one or more diode bars, that are combined using a dispersive element to form a multi-wavelength beam. Each emitter in the WBC system individually resonates, and is stabilized through wavelength-specific feedback from a common partially reflecting output coupler that is filtered by the dispersive element along a beam-combining dimension. Exemplary WBC systems are detailed in U.S. Pat. No. 6,192,062, filed on Feb. 4, 2000, U.S. Pat. No. 6,208,679, filed on Sep. 8, 1998, U.S. Pat. No. 8,670,180, filed on Aug. 25, 2011, and U.S. Pat. No. 8,559,107, filed on Mar. 7, 2011, the entire disclosure of each of which is incorporated by reference herein. Multi-wavelength output beams of WBC systems may be utilized as input beams in conjunction with embodiments of the present invention for, e.g., BPP control. Thus, in various embodiments, a laser beam source includes, consists essentially of, or consists of a WBC laser emitting a broadband, multi-wavelength laser beam. In various embodiments, such lasers may have bandwidths ranging from, for example, approximately 10 nm to approximately 60 nm. The laser beam source may be a direct-diode laser source, as opposed to a fiber or chemical laser.

Output beams produced in accordance with embodiments of the present invention may be utilized to process a workpiece such that the surface of the workpiece is physically altered and/or such that a feature is formed on or within the surface, in contrast with optical techniques that merely probe a surface with light (e.g., reflectivity measurements) and with optical beams utilized for data transmission. Exemplary processes in accordance with embodiments of the invention include cutting, welding, drilling, and soldering. As such, optical fibers detailed herein may have at their output ends a laser head configured to focus the output beam from the fiber toward a workpiece to be processed. The laser head may include, consist essentially of, or consist of one or more optical elements for focusing and/or collimating the output beam, and/or controlling the polarization and/or the trajectory of the beam. The laser head may be positioned to emit the output beam toward a workpiece and/or toward a platform or positionable gantry on which the workpiece may be disposed.

Various embodiments of the invention may also process workpieces at one or more spots or along a one-dimensional linear or curvilinear processing path, rather than flooding all or substantially all of the workpiece surface with radiation from the laser beam. In general, processing paths may be curvilinear or linear, and “linear” processing paths may feature one or more directional changes, i.e., linear processing paths may be composed of two or more substantially straight segments that are not necessarily parallel to each other. Similarly, “curvilinear” paths may be composed of multiple curvilinear segments with directional changes therebetween. Other processing paths in accordance with embodiments of the invention include segmented paths in which each segment is linear or curvilinear, and a directional change may be present between any two of the segments.

Embodiments of the invention may vary beam shape and/or BPP to improve or optimize performance for different types of processing techniques or different types of materials being processed. Embodiments of the invention may utilize various additional techniques for varying BPP and/or shape of laser beams described in U.S. patent application Ser. No. 14/632,283, filed on Feb. 26, 2015, U.S. patent application Ser. No. 14/747,073, filed Jun. 23, 2015, U.S. patent application Ser. No. 14/852,939, filed Sep. 14, 2015, U.S. patent application Ser. No. 15/188,076, filed Jun. 21, 2016, U.S. patent application Ser. No. 15/479,745, filed Apr. 5, 2017, and U.S. patent application Ser. No. 15/649,841, filed Jul. 14, 2017, the disclosure of each of which is incorporated in its entirety herein by reference.

In an aspect, embodiments of the invention feature a method of processing a workpiece with a laser beam. A step-core optical fiber having an input end and an output end opposite the input end is provided. The step-core optical fiber includes, consists essentially of, or consists of (i) an inner core having a first refractive index, (ii) surrounding the inner core, an outer core having a second refractive index smaller than the first refractive index, and (iii) surrounding the outer core, a cladding having a third refractive index smaller than the second refractive index. The step-core optical fiber has (a) a first inner core numerical aperture (NA) relative to the cladding, (b) a second inner core NA relative to the outer core, and (c) an outer core NA relative to the cladding. A workpiece is disposed proximate the output end of the optical fiber. A variable-power laser beam having a laser-beam NA that varies as a function of the power of the laser beam is directed into the input end of the optical fiber. An output beam emitted from the output end of the optical fiber is generated. The outer core NA is greater than or equal to the laser-beam NA at a power of approximately 100%, (ii) the second inner core NA is less than or equal to the outer core NA, and (iii) the second inner core NA is greater than or equal to the laser-beam NA at a power of 50%. The workpiece is processed with the output beam.

Embodiments of the invention may include one or more of the following in any of a variety of combinations. The workpiece may be processed along a processing path extending across at least a portion of the workpiece. Processing the workpiece may include, consist essentially of, or consist of physically altering at least a portion of a surface of the workpiece and/or at least a portion of the workpiece. Processing the workpiece may include, consist essentially of, or consist of cutting, welding, etching, annealing, drilling, soldering, and/or brazing. The laser beam may generate a non-circular spot on the input end of the optical fiber, e.g., a spot that is elliptical or rectangular. The spot may have first and second lateral dimensions that are different from each other and perpendicular to each other. The first lateral dimension may be larger than the second lateral dimension. A diameter or lateral dimension of the outer core may be larger than the first lateral dimension of the spot. A diameter or lateral dimension of the inner core may be larger than the second lateral dimension of the spot. A diameter or lateral dimension of the inner core may be smaller than the first lateral dimension of the spot. A diameter or lateral dimension of the inner core may be smaller than the second lateral dimension of the spot. A cross-sectional shape of the inner core may be non-circular, e.g., rectangular, elliptical, square, triangular, polygonal, etc. A central axis of the inner core may not be coaxial with a central axis of the outer core and/or a central axis of the cladding and/or a central axis of the optical fiber. The laser beam may generate a spot on the input end of the optical fiber, and the spot may be larger than a diameter of the inner core and smaller than a diameter of the outer core.

The laser beam may be emitted from a beam emitter. The beam emitter may include, consist essentially of, or consist of one or more beam sources emitting a plurality of discrete beams, focusing optics for focusing the plurality of beams toward a dispersive element, the dispersive element for receiving and dispersing the received focused beams, and a partially reflective output coupler positioned to receive the dispersed beams, transmit a portion of the dispersed beams therethrough as the laser beam, and reflect a second portion of the dispersed beams back toward the dispersive element. The laser beam may be composed of multiple wavelengths. The dispersive element may include, consist essentially of, or consist of a diffraction grating (e.g., a transmissive diffraction grating or a reflective diffraction grating), and may have one or more prisms associated therewith. The dispersive element may be in contact with at least one prism and/or may receive beams from and/or transmit beams to the prism(s). The output end of the optical fiber may be coupled to a laser head containing one or more optical elements therein. The beam may be rotated using the laser head before and/or during processing of the workpiece.

In another aspect, embodiments of the invention feature a method of processing a workpiece with a laser beam. A step-core optical fiber having an input end and an output end opposite the input end is provided. The step-core optical fiber includes, consists essentially of, or consists of (i) an inner core having a first refractive index, (ii) surrounding the inner core, an outer core having a second refractive index smaller than the first refractive index, and (iii) surrounding the outer core, a cladding having a third refractive index smaller than the second refractive index. The step-core optical fiber has (a) a first inner core numerical aperture (NA) relative to the cladding, (b) a second inner core NA relative to the outer core, and (c) an outer core NA relative to the cladding. A central axis of the inner core is not coaxial with a central axis of the outer core and/or a central axis of the cladding and/or a central axis of the optical fiber. A workpiece is disposed proximate the output end of the optical fiber. A laser beam is directed into the input end of the optical fiber to thereby generate an output beam emitted from the output end of the optical fiber. The laser beam may have a laser-beam NA that varies as a function of the power of the laser beam. The workpiece is processed with the output beam.

Embodiments of the invention may include one or more of the following in any of a variety of combinations. The laser beam may be, include, consist essentially of, or consist of a variable-power laser beam having a laser-beam NA that varies as a function of the power of the laser beam. The outer core NA may be greater than or equal to the laser-beam NA at a power of approximately 100%. The second inner core NA may be less than or equal to the outer core NA. The second inner core NA may be greater than or equal to the laser-beam NA at a power of 50%. The workpiece may be processed along a processing path extending across at least a portion of the workpiece. Processing the workpiece may include, consist essentially of, or consist of physically altering at least a portion of a surface of the workpiece and/or at least a portion of the workpiece. Processing the workpiece may include, consist essentially of, or consist of cutting, welding, etching, annealing, drilling, soldering, and/or brazing. The laser beam may generate a non-circular spot on the input end of the optical fiber, e.g., a spot that is elliptical or rectangular. The spot may have first and second lateral dimensions that are different from each other and perpendicular to each other. The first lateral dimension may be larger than the second lateral dimension. A diameter or lateral dimension of the outer core may be larger than the first lateral dimension of the spot. A diameter or lateral dimension of the inner core may be larger than the second lateral dimension of the spot. A diameter or lateral dimension of the inner core may be smaller than the first lateral dimension of the spot. A diameter or lateral dimension of the inner core may be smaller than the second lateral dimension of the spot. A cross-sectional shape of the inner core may be non-circular, e.g., rectangular, elliptical, square, triangular, polygonal, etc. A central axis of the laser beam may not be coaxial with a central axis of the inner core and/or a central axis of the outer core and/or a central axis of the cladding and/or a central axis of the optical fiber. A central axis of the laser beam may be coaxial with a central axis of the outer core and/or a central axis of the cladding and/or a central axis of the optical fiber. The laser beam may generate a spot on the input end of the optical fiber, and the spot may be larger than a diameter of the inner core and smaller than a diameter of the outer core.

The laser beam may be emitted from a beam emitter. The beam emitter may include, consist essentially of, or consist of one or more beam sources emitting a plurality of discrete beams, focusing optics for focusing the plurality of beams toward a dispersive element, the dispersive element for receiving and dispersing the received focused beams, and a partially reflective output coupler positioned to receive the dispersed beams, transmit a portion of the dispersed beams therethrough as the laser beam, and reflect a second portion of the dispersed beams back toward the dispersive element. The laser beam may be composed of multiple wavelengths. The dispersive element may include, consist essentially of, or consist of a diffraction grating (e.g., a transmissive diffraction grating or a reflective diffraction grating), and may have one or more prisms associated therewith. The dispersive element may be in contact with at least one prism and/or may receive beams from and/or transmit beams to the prism(s). The output end of the optical fiber may be coupled to a laser head containing one or more optical elements therein. The beam may be rotated using the laser head before and/or during processing of the workpiece.

In yet another aspect, embodiments of the invention feature a method of processing a workpiece with a laser beam. A step-core optical fiber having an input end and an output end opposite the input end is provided. The step-core optical fiber includes, consists essentially of, or consists of (i) a plurality of non-coaxial inner cores each having a first refractive index, (ii) surrounding and extending between the inner cores, an outer core having a second refractive index smaller than the first refractive index, and (iii) surrounding the outer core, a cladding having a third refractive index smaller than the second refractive index. A workpiece is disposed proximate the output end of the optical fiber. A laser beam is directed into the input end of the optical fiber to thereby generate an output beam emitted from the output end of the optical fiber. The laser beam may have a laser-beam NA that varies as a function of the power of the laser beam. The workpiece is processed with the output beam.

Embodiments of the invention may include one or more of the following in any of a variety of combinations. The first refractive indices of all of the inner cores may be approximately equal to each other. The first refractive indices of at least two of the inner cores may be different. The first refractive indices of all of the inner cores may be different. The laser beam may be, include, consist essentially of, or consist of a variable-power laser beam having a laser-beam numerical aperture (NA) that varies as a function of the power of the laser beam. The step-core optical fiber may have an outer core NA relative to the cladding. The outer core NA may be greater than or equal to the laser-beam NA at a power of approximately 100%. One or more of the inner cores may have an inner core NA relative to the outer core. The inner core NA of one or more, or even each, inner core may be less than the outer core NA. The inner core NA of one or more, or even each, inner core may be greater than the laser-beam NA at a power of 50%. A central axis of one of the inner cores may be coaxial with a central axis of the outer core. A central axis of the outer core may not be coaxial with a central axis of any of the inner cores. A cross-sectional shape of one or more of the inner cores may be non-circular, e.g., rectangular, elliptical, square, triangular, polygonal, etc. A central axis of the laser beam may not be coaxial with a central axis of one or more (or even all) of the inner cores and/or a central axis of the outer core and/or a central axis of the cladding and/or a central axis of the optical fiber. A central axis of the laser beam may be coaxial with a central axis of the outer core and/or a central axis of the cladding and/or a central axis of the optical fiber and/or one of the inner cores.

The workpiece may be processed along a processing path extending across at least a portion of the workpiece. Processing the workpiece may include, consist essentially of, or consist of physically altering at least a portion of a surface of the workpiece and/or at least a portion of the workpiece. Processing the workpiece may include, consist essentially of, or consist of cutting, welding, etching, annealing, drilling, soldering, and/or brazing. The laser beam may generate a non-circular spot on the input end of the optical fiber, e.g., a spot that is elliptical or rectangular. The spot may have first and second lateral dimensions that are different from each other and perpendicular to each other. The first lateral dimension may be larger than the second lateral dimension. A diameter or lateral dimension of the outer core may be larger than the first lateral dimension of the spot. A diameter or lateral dimension of one or more (or even all) of the inner cores may be larger than the second lateral dimension of the spot. A diameter or lateral dimension of one or more (or even all) of the inner cores may be smaller than the first lateral dimension of the spot. A diameter or lateral dimension of one or more (or even all) of the inner cores may be smaller than the second lateral dimension of the spot.

The laser beam may be emitted from a beam emitter. The beam emitter may include, consist essentially of, or consist of one or more beam sources emitting a plurality of discrete beams, focusing optics for focusing the plurality of beams toward a dispersive element, the dispersive element for receiving and dispersing the received focused beams, and a partially reflective output coupler positioned to receive the dispersed beams, transmit a portion of the dispersed beams therethrough as the laser beam, and reflect a second portion of the dispersed beams back toward the dispersive element. The laser beam may be composed of multiple wavelengths. The dispersive element may include, consist essentially of, or consist of a diffraction grating (e.g., a transmissive diffraction grating or a reflective diffraction grating), and may have one or more prisms associated therewith. The dispersive element may be in contact with at least one prism and/or may receive beams from and/or transmit beams to the prism(s). The output end of the optical fiber may be coupled to a laser head containing one or more optical elements therein. The beam may be rotated using the laser head before and/or during processing of the workpiece.

In another aspect, embodiments of the invention feature a method of processing a workpiece utilizing a primary laser beam and a secondary laser beam. A wavelength of the primary laser beam is longer than a wavelength of the secondary laser beam. A step-core optical fiber having an input end and an output end opposite the input end is provided. The step-core optical fiber includes, consists essentially of, or consists of (i) an inner core having a first refractive index, (ii) surrounding the inner core, an outer core having a second refractive index smaller than the first refractive index, and (iii) surrounding the outer core, a cladding having a third refractive index smaller than the second refractive index. The step-core optical fiber has (a) a first inner core numerical aperture (NA) relative to the cladding, (b) a second inner core NA relative to the outer core, and (c) an outer core NA relative to the cladding. A workpiece is disposed proximate the output end of the optical fiber. During a first stage, at least the secondary laser beam is coupled into the optical fiber to form a first output beam emitted from the output end of the optical fiber and directed to a surface of the workpiece, whereby energy of the first output beam is absorbed by the workpiece. During a second stage after at least a portion of the surface of the workpiece reacts to absorption of energy of the first output beam, (i) at least the primary laser beam is coupled into the optical fiber to form a second output beam emitted from the output end of the optical fiber and directed to the surface of the workpiece, and (ii) thereduring, relative movement between the second output beam and the workpiece is caused, whereby the workpiece is cut along a processing path determined at least in part by the relative movement.

Embodiments of the invention may include one or more of the following in any of a variety of combinations. The primary laser beam may be, include, consist essentially of, or consist of a variable-power laser beam having a laser-beam NA that varies as a function of the power of the primary laser beam. The outer core NA may be greater than or equal to the laser-beam NA of the primary laser beam at a power of approximately 100%. The second inner core NA may be less than or equal to the outer core NA. The second inner core NA may be greater than or equal to the laser-beam NA of the primary laser beam at a power of 50%. The secondary laser beam may be, include, consist essentially of, or consist of a variable-power laser beam having a laser-beam NA that varies as a function of the power of the secondary laser beam. The second inner core NA may be less than or equal to the outer core NA. The second inner core NA may be greater than or equal to the laser-beam NA of the secondary laser beam at a power of approximately 100%.

During at least the first stage, the secondary laser beam may overlap the inner core but may not overlap the outer core. During at least the second stage, the primary laser beam may overlap the inner core and overlap the outer core. The primary laser beam may generate a non-circular spot on the input end of the optical fiber, e.g., a spot that is elliptical or rectangular. The secondary laser beam may generate a non-circular spot on the input end of the optical fiber, e.g., a spot that is elliptical or rectangular. A cross-sectional shape of the inner core may be non-circular, e.g., rectangular, elliptical, square, triangular, polygonal, etc. A central axis of the inner core may not be coaxial with a central axis of the outer core and/or a central axis of the cladding and/or a central axis of the optical fiber. The primary laser beam may not be coupled into the optical fiber during the first stage. The secondary laser beam may not be coupled into the optical fiber during the second stage. The primary laser beam may be coupled into the optical fiber during the first stage. An output power of the primary laser beam during the first stage may be lower than an output power of the primary laser beam during the second stage. The secondary laser beam may be coupled into the optical fiber during the second stage. An output power of the secondary laser beam during the second stage may be lower than an output power of the secondary laser beam during the first stage.

The wavelength of the primary laser beam may range from approximately 870 nm to approximately 11 μm. The wavelength of the primary laser beam may range from approximately 870 nm to approximately 1064 nm. The wavelength of the primary laser beam may range from approximately 870 nm to approximately 1000 nm. The wavelength of the secondary laser beam may range from approximately 300 nm to approximately 810 nm. The wavelength of the secondary laser beam may range from approximately 400 nm to approximately 810 nm. The wavelength of the secondary laser beam may range from approximately 530 nm to approximately 810 nm.

At least the surface of the workpiece may include, consist essentially of, or consist of a metallic material. At least the surface of the workpiece may include, consist essentially of, or consist of aluminum, copper, iron, steel, gold, silver, and/or molybdenum. Before initiating the second stage, a determination may be made that the at least a portion of the surface of the workpiece is molten based on a reflectivity and/or a temperature of the surface of the workpiece. During the second stage, at least the secondary laser beam may be coupled into the optical fiber at one or more points along the processing path at which (i) a thickness of the workpiece changes, (ii) a direction of the processing path changes, and/or (iii) a composition of the workpiece changes. A hole may be formed through at least a portion of a thickness of the workpiece during the first stage and before the second stage. A hole may not be formed through a thickness of the workpiece before initiation of the second stage.

In yet another aspect, embodiments of the invention feature a laser system for processing a workpiece. The laser system includes, consists essentially of, or consists of a step-core optical fiber having an input end and an output end opposite the input end, a primary laser emitter configured to emit a primary laser beam, a secondary laser emitter configured to emit a secondary laser beam, a coupling mechanism for coupling the primary laser beam and the secondary laser beam into the input end of the optical fiber, and a computer-based controller. A wavelength of the primary laser beam is longer than a wavelength of the secondary laser beam. The step-core optical fiber includes, consists essentially of, or consists of (i) an inner core having a first refractive index, (ii) surrounding the inner core, an outer core having a second refractive index smaller than the first refractive index, and (iii) surrounding the outer core, a cladding having a third refractive index smaller than the second refractive index. The step-core optical fiber has (a) a first inner core numerical aperture (NA) relative to the cladding, (b) a second inner core NA relative to the outer core, and (c) an outer core NA relative to the cladding. The controller is configured to, during a first stage, couple at least the secondary laser beam into the optical fiber to form a first output beam emitted from the output end of the optical fiber and directed to a surface of the workpiece, whereby energy of the first output beam is absorbed by the workpiece. The controller is configured to, during a second stage after at least a portion of the surface of the workpiece reacts to absorption of energy of the first output beam, (i) couple at least the primary laser beam into the optical fiber to form a second output beam emitted from the output end of the optical fiber and directed to the surface of the workpiece, and (ii) thereduring, cause relative movement between the second output beam and the workpiece, whereby the workpiece is cut along a processing path determined at least in part by the relative movement.

Embodiments of the invention may include one or more of the following in any of a variety of combinations. The coupling mechanism may include, consist essentially of, or consist of at least one reflector (e.g., a dichroic mirror) and/or one or more focusing optics (e.g., a focusing lens). The primary laser beam may be, include, consist essentially of, or consist of a variable-power laser beam having a laser-beam NA that varies as a function of the power of the primary laser beam. The outer core NA may be greater than or equal to the laser-beam NA of the primary laser beam at a power of approximately 100%. The second inner core NA may be less than or equal to the outer core NA. The second inner core NA may be greater than or equal to the laser-beam NA of the primary laser beam at a power of 50%. The secondary laser beam may be, include, consist essentially of, or consist of a variable-power laser beam having a laser-beam NA that varies as a function of the power of the secondary laser beam. The second inner core NA may be less than or equal to the outer core NA. The second inner core NA may be greater than or equal to the laser-beam NA of the secondary laser beam at a power of approximately 100%.

During at least the first stage, the controller may be configured to couple the secondary laser beam into the optical fiber such that the secondary laser beam overlaps the inner core but does not overlap the outer core. During at least the second stage, the controller may be configured to couple the primary laser beam into the optical fiber such that the primary laser beam overlaps the inner core and overlaps the outer core. The primary laser beam may generate a non-circular spot on the input end of the optical fiber, e.g., a spot that is elliptical or rectangular. The secondary laser beam may generate a non-circular spot on the input end of the optical fiber, e.g., a spot that is elliptical or rectangular. A cross-sectional shape of the inner core may be non-circular, e.g., rectangular, elliptical, square, triangular, polygonal, etc. A central axis of the inner core may not be coaxial with a central axis of the outer core and/or a central axis of the cladding and/or a central axis of the optical fiber.

The controller may be configured to not couple the primary laser beam into the optical fiber during the first stage. The controller may be configured to not couple the secondary laser beam into the optical fiber during the second stage. The controller may be configured to couple the primary laser beam into the optical fiber during the first stage. The controller may be configured to couple the primary laser beam into the optical fiber (i) during the first stage with a first output power and (ii) during the second stage with a second output power higher than the first output power. The controller may be configured to couple the secondary laser beam into the optical fiber during the second stage. The controller may be configured to couple the secondary laser beam into the optical fiber (i) during the first stage with a first output power and (ii) during the second stage with a second output power lower than the first output power.

The laser system may include one or more sensors. The controller may be configured to determine that the at least a portion of the surface of the workpiece is molten based at least in part on signals received from the one or more sensors. The one or more sensors may include, consist essentially of, or consist of one or more optical sensors and/or one or more temperature sensors. The controller may be configured to, during the second stage, couple at least the secondary laser beam into the optical fiber at one or more points along the processing path at which (i) a thickness of the workpiece changes, (ii) a direction of the processing path changes, and/or (iii) a composition of the workpiece changes. The controller may be configured to initiate the second stage only after a hole is formed through at least a portion of a thickness of the workpiece during the first stage. The controller may be configured to initiate the second stage before a hole is formed through a thickness of the workpiece during the first stage.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and may exist in various combinations and permutations. As used herein, the term “substantially” means±10%, and in some embodiments, ±5%. The term “consists essentially of” means excluding other materials that contribute to function, unless otherwise defined herein. Nonetheless, such other materials may be present, collectively or individually, in trace amounts. Herein, the terms “radiation” and “light” are utilized interchangeably unless otherwise indicated. Herein, “downstream” or “optically downstream,” is utilized to indicate the relative placement of a second element that a light beam strikes after encountering a first element, the first element being “upstream,” or “optically upstream” of the second element. Herein, “optical distance” between two components is the distance between two components that is actually traveled by light beams; the optical distance may be, but is not necessarily, equal to the physical distance between two components due to, e.g., reflections from mirrors or other changes in propagation direction experienced by the light traveling from one of the components to the other. Distances utilized herein may be considered to be “optical distances” unless otherwise specified.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a refractive index profile of a conventional step-index optical fiber;

FIG. 2 is a refractive index profile of a step-core optical fiber in accordance with various embodiments of the invention;

FIG. 3A is a schematic diagram of an input beam at the entrance of the optical fiber of FIG. 1;

FIG. 3B is a schematic diagram of the exit beam corresponding to the input beam of FIG. 3A;

FIG. 3C is a schematic diagram of an input beam at the entrance of the optical fiber of FIG. 2 in accordance with various embodiments of the invention;

FIG. 3D is a schematic diagram of the exit beam corresponding to the input beam of FIG. 3C in accordance with various embodiments of the invention;

FIG. 4A graphically depicts simulation results of output-beam BPP as a function of inner core diameter in accordance with various embodiments of the invention;

FIG. 4B graphically depicts simulation results of output-beam spot size as a function of inner core diameter in accordance with various embodiments of the invention;

FIGS. 5A-5C graphically depict output beam profiles for various conditions within the simulations of FIGS. 4A and 4B in accordance with various embodiments of the invention;

FIG. 6A is a refractive index profile of a decentered step-core optical fiber in accordance with various embodiments of the invention;

FIGS. 6B and 6C respectively depict an image of the beam at the fiber exit and a cross-sectional profile of the beam at the exit, corresponding to a beam coupled into the decentered step-core fiber of FIG. 6A, in accordance with various embodiments of the invention;

FIG. 7A is a schematic cross-section of an exemplary step-core optical fiber having multiple inner or center cores in accordance with various embodiments of the invention;

FIG. 7B is an image of a beam at the exit of the optical fiber of FIG. 7A in accordance with various embodiments of the invention;

FIGS. 7C and 7D are cross-sectional beam intensity profiles along the horizontal axis (FIG. 7C) and the vertical axis (FIG. 7D) of FIG. 7B, in accordance with various embodiments of the invention;

FIG. 8 is a schematic diagram of a wavelength beam combining (WBC) resonator in accordance with embodiments of the invention;

FIG. 9A is a schematic view of a first side of a laser resonator in accordance with various embodiments of the invention;

FIG. 9B is a schematic view of a second side of a laser resonator in accordance with various embodiments of the invention;

FIG. 10 is a schematic diagram of a laser system coupling multiple laser beams into a step-core optical fiber in accordance with various embodiments of the invention; and

FIG. 11 is a schematic diagram of a laser engine featuring multiple laser resonators in accordance with various embodiments of the invention.

### DETAILED DESCRIPTION

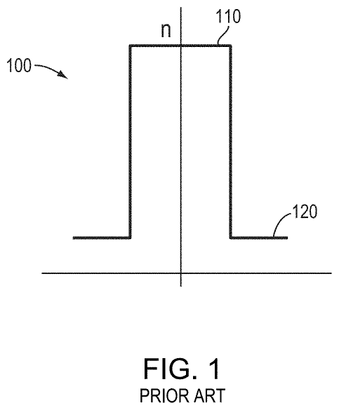

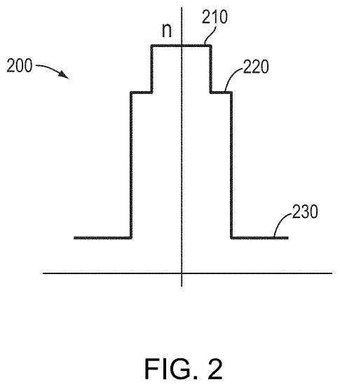

FIG. 1 depicts the refractive index profile of a conventional step-index optical fiber 100 utilized for high-power beam delivery. As shown, the step-index fiber 100 has a center core 110 having a higher refractive index than that of the surrounding cladding 120. In contrast, FIG. 2 depicts the refractive index profile of a step-core optical fiber 200 in accordance with embodiments of the present invention. As shown, the step-core fiber 200 includes, consists essentially of, or consists of an inner central core 210, an outer ring or annular core 220 surrounding the inner core 210, and a cladding 230 surrounding the annular core 220. In accordance with embodiments of the invention, the inner core 210 has higher refractive index than that of the outer ring core 220 so that a majority, or even substantially all, of the power initially coupled into the inner core 210 is confined within the inner core 210. In various embodiments, the diameter of the inner central core 210 ranges from, for example, approximately 10% to approximately 90%, or approximately 20% to approximately 80%, or approximately 30% to approximately 70%, or approximately 40% to approximately 60%, of the diameter of the outer ring core 220.

Various embodiments of the invention include step-core fibers having multiple inner cores, where the outer core extends around and between the various inner cores. In such embodiments, the diameter of each inner core ranges from, for example, approximately 10% to approximately 90% of the diameter of the outer ring core divided by the number of inner cores, or approximately 20% to approximately 80% of the diameter of the outer ring core divided by the number of inner cores, or approximately 30% to approximately 70% of the diameter of the outer ring core divided by the number of inner cores, or approximately 40% to approximately 60% of the diameter of the outer ring core divided by the number of inner cores. In various embodiments, whether the step-core fiber features a single or multiple inner cores, each inner core may support multiple (e.g., at least three, at least five, or at least 10) modes therein (i.e., may be “multi-mode”).

In various embodiments, the numerical aperture (NA) of the inner core of the step-core fiber may be less than 0.14, or less than 0.12, or less than 0.10. In various embodiments, the NA of the inner core of the step-core fiber may be greater than or equal to 0.07. In various embodiments, the NA of the outer core of the step-core fiber may be larger than the NA of the inner core. For example, the NA of the outer core may be larger than 0.15, or larger than 0.18, or larger than 0.20. In exemplary embodiments of the invention, if the fiber overall NA (i.e., of the inner core relative to the cladding) is denoted as NA₀, and inner core NA (relative to outer ring core) is denoted as NA₁, then the outer ring core NA (NA₂) is calculated as NA₂=sqrt(NA₀²−NA₁²). Typical power-delivery fiber composed of fused silica has a NA₀=0.22. If NA₁=0.12, then NA₂=0.18. In various embodiments, the outer core NA is less than or equal to approximately 0.21 (e.g., when NA₁ is 0.07). In various embodiments of the invention, the outer core NA (NA₂) is greater than or equal to the inner core NA relative to the outer core (NA₁).

In various embodiments, the diameter of the outer core may range from, for example, approximately 30 μm to approximately 200 μm, approximately 50 μm to approximately 150 μm, or approximately 60 μm to approximately 120 μm. In various embodiments, the diameter of the inner core may range from approximately 30% to approximately 95%, or from approximately 50% to approximately 90%, of the diameter of the outer ring core (e.g., for fibers having a single inner core). For example, assuming an outer core diameter of 100 μm, embodiments of the invention may enable (1) a smaller effective spot size via selection of a relatively larger inner core (e.g., an inner core diameter ranging from approximately 80 μm to 90 μm) so that most of the power is in-coupled and confined within the inner core, or (2) a higher peak intensity via selection of a relatively smaller inner core (e.g., an inner core diameter ranging from approximately 30 μm to 70 μm).

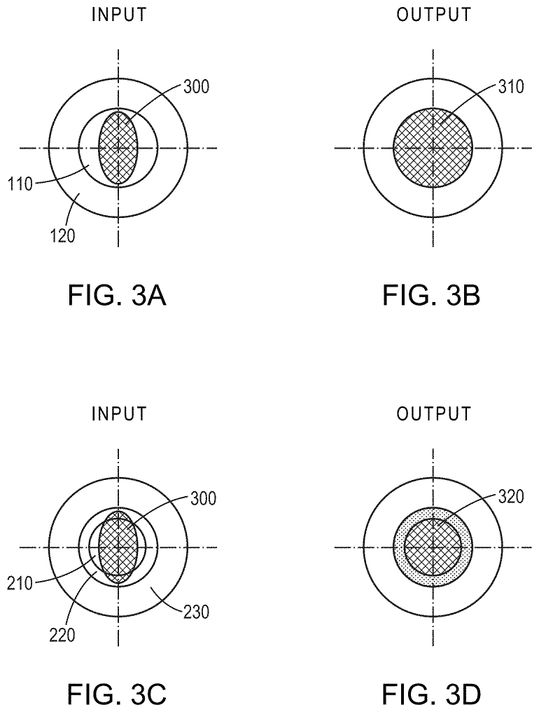

FIGS. 3A-3D compare and contrast the resulting beam outputs, given the same input beam spot size and shape, when utilizing the conventional step-index fiber 100 of FIG. 1 and the step-core fiber 200, of FIG. 2, in accordance with embodiments of the invention. As shown, in accordance with various embodiments of the invention, the input beam spot 300 is not circular. Rather, the input beam spot may be oblong, elliptical, or even rectangular. Such non-circular beams are often generated by high-power direct-diode lasers, given the physical shapes of such emitters. Referring to FIGS. 3A and 3B, the non-circular input beam 300 must be coupled into a core region 110 of the conventional fiber 100 that is larger than the largest dimension of the beam 300, and thus a large portion of area at the fiber input is not filled with laser power. As shown in FIG. 3B, at the output, the beam expands to fill the larger circular inner core 110, resulting in substantial BPP degradation of the beam when the output beam 310 is formed.

In contrast, referring to FIGS. 3C and 3D, in accordance with embodiments of the invention the non-circular beam 300 overlaps both the center core 210 and the outer core 220 of the step-core fiber 200. That is, in accordance with embodiments of the invention the diameter of the center core 210 is less than the largest dimension of the input beam 300 (or even less than the smallest dimension of the input beam 300), while the outer diameter of the annular core 220 is greater than or approximately equal to this largest dimension of the input beam 300. As shown, the portion of the area without input power inside the inner core 210 is much less compared to when the conventional fiber 100 is used, and the majority of the power is confined within the inner core 210. This results in an output beam 320 having a smaller effective spot size, higher peak intensity, and less degradation of BPP without sacrificing coupling efficiency and stability.

Moreover, embodiments of the invention accomplish generation of output beams with less BPP degradation even utilizing circular inner and outer cores, and do not necessitate fabrication of optical fibers having inner core or cladding regions that are themselves non-circular (e.g., elliptical, rectangular, etc.) in order to efficiently confine a non-circular input beam. Thus, fibers in accordance with embodiments of the invention may be fabricated more easily and inexpensively than more exotic fibers having regions shaped to accommodate non-circular beams.

Various embodiments of the invention couple multiple beams, each having a different wavelength, into the step-core fiber, while minimizing or reducing overall BPP degradation of the resulting output beam(s). The beams may be coupled into the step-core fiber simultaneously or individually (e.g., in sequence). Such embodiments, as described in additional detail below, may be utilized to facilitate processing of various materials having wavelength-dependent properties such as absorbance or reflectance. Each of the different input beams may be circular or non-circular. In various embodiments, a primary input beam having a longer wavelength may be coupled into the step-core fiber as shown in FIG. 3C, i.e., the spot (which may be circular or non-circular) may overlap not only the inner core but also the outer core, enabling less BPP degradation in the resulting output beam. In addition, a secondary input beam having a shorter wavelength may be coupled into the step-core fiber such that the spot (which again, may be circular or non-circular) only overlaps the inner core. The primary and secondary beams may be coupled into the step-core fiber with the same focusing optics, which may focus the secondary beam to a smaller input spot size than the primary beam. In such embodiments, overall BPP degradation is reduced or minimized while obviating the need for more exotic or complicated in-coupling techniques or apparatuses.

In order to illustrate the general principle of utilization of step-core fibers and the resulting benefits of embodiments of the invention, numerical simulations were performed to investigate the BPP and output beam spot size. In the simulations, the outer core diameter of the step-core fiber was set at 100 μm, while the diameter of the inner core was varied between 40 μm and 100 μm. (At an inner core diameter of 100 μm, the modeled fiber is equivalent to a conventional step-index fiber having a single core because the inner and outer core diameters are the same.) The numerical aperture (NA) of the inner core relative to the outer core was 0.1 and the NA of the inner core relative to the cladding was 0.22. The NA of the outer core relative to the cladding was 0.196. The input beam had a wavelength of 975 nm, and the refractive indices of the inner core, outer core, and cladding were, respectively, 1.45076, 1.44731, and 1.434.

The simulated input beam produced a rectangular spot on the fiber input with spot size in two vertical (and perpendicular) dimensions of about 61 μm and 83 μm, respectively, and with corresponding input NA of about 0.075 and 0.095. Because the input beam is asymmetric, the input spot size and NA are measured as one-dimensional two-sigma values, equivalent to one-dimensional 95% power content. The input BPP values at two-sigma in the two directions may be calculated as 2.3 mm.mrad (=61/2×0.075) and 3.94 mm.mrad (=83/2×0.095), corresponding to a combined BPP of about 3.0 mm.mrad (=sqrt(2.3×3.94)).

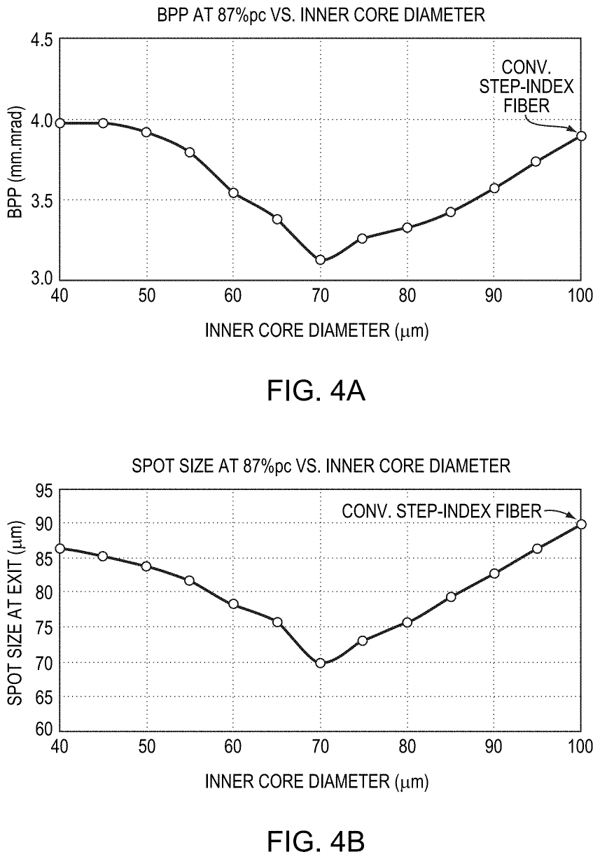

FIGS. 4A and 4B depict the results of the simulations, respectively showing BPP and spot size, at the beam exit from the fiber, measured as two-dimensional two-sigma values, equivalent to two-dimensional 87% power content. (BPP at 87% power content is typically used for high-power lasers as a beam-quality indicator, as known to those of skill in the art.) As mentioned above, the simulated example step-core fiber has an outer core diameter of 100 μm, and therefore, it is equivalent to a conventional 100 μm-core step-index fiber when the inner core diameter is increased to 100 μm; the corresponding rightmost data points, as indicated by the arrows on the graphs, are the base points for comparison. As shown, these comparative conventional data points for the step-index fiber are a BPP of 3.9 mm.mrad (arrow in FIG. 4A) and a spot size of 90 μm (arrow in FIG. 4B). Comparing this BPP with the input BPP calculated above, the BPP degradation using the conventional step-index fiber is about 30%, i.e., the BPP is increased by about 30%.

In contrast, FIG. 4A shows that significant BPP reduction is achieved when using a step-core fiber in accordance with embodiments of the present invention, and that such reduction is maximized with an inner core diameter of about 70 μm, where the BPP is about 3.13 mm.mrad, or about 25% smaller than the BPP for the conventional step-index fiber. When comparing to the input BPP of approximately 3.0, the BPP degradation is only about 4%. As shown in FIG. 4B, the BPP reduction or improvement is mainly due to the decrease of the effective spot size at the output. In addition (but not shown on the graph), the output NA is slightly increased by up to a few percent when the inner core diameter is decreased down to 40 μm, because some rays initially coupled into the outer ring core exit from the inner core.

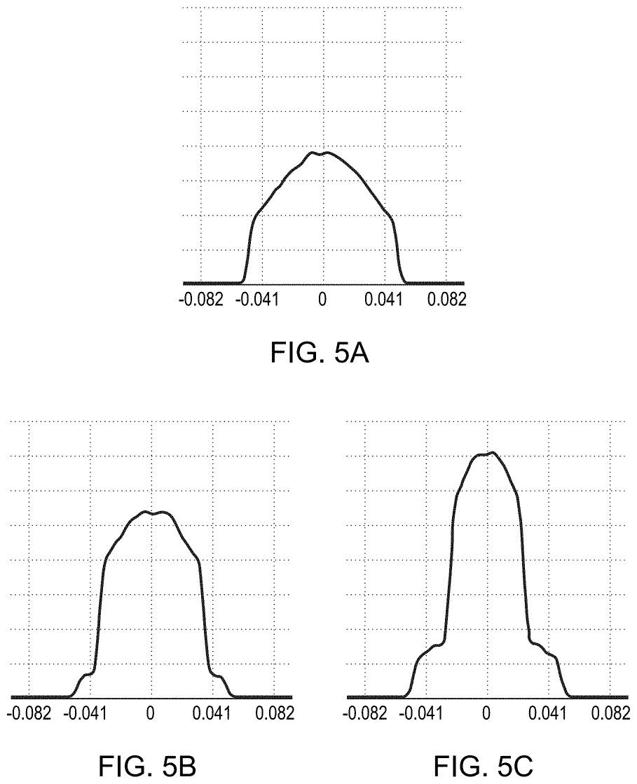

FIGS. 5A-5C graphically depict the exit beam profiles for various conditions within the simulations of FIGS. 4A and 4B. The parameters corresponding to each of the depicted profiles are summarized in the table below. FIG. 5A corresponds to the conventional step-index fiber summarized above and represented by the rightmost data points in FIG. 4A and FIG. 4B, while FIGS. 5B and 5C correspond to step-core fibers, in accordance with embodiments of the present invention, having different inner core diameters.

| Profile | FIG. 5A | FIG. 5B | FIG. 5C |
|---|---|---|---|
| Inner core diameter (μm) | 100 | 70 | 50 |
| BPP at 87% pc (mm · mrad) | 3.9 | 3.13 | 4.0 |
| BPP degradation relative to input | 30% | 4% | 33% |
| Relative peak intensity | 1 | 1.45 | 1.9 |
| Beam diameter at 87% pc (μm) | 90 | 70 | 85 |
| Full-power beam diameter (μm) | 100 | 100 | 100 |

As shown in the above table and in FIGS. 5A-5C, the step-core fibers in accordance with embodiments of the invention exhibit significantly higher peak beam intensities and smaller beam diameters (at 87% power content) at the exit. Such advantages may be quite significant for some applications, such as thinner metal cutting and drilling. Moreover, FIGS. 5B and 5C demonstrate how BPP and peak beam intensity may be traded off in step-core fibers in accordance with embodiments of the invention. As shown in FIG. 5C and the associated parameters in the table, although in this example case the BPP is not improved compared to the use of the conventional step-index fiber (FIG. 5A), the peak intensity is almost doubled compared to this case, which may be significant for some applications (e.g., thinner metal cutting and drilling).

In conventional laser systems, for a particular laser power, higher intensity may be achieved by using a smaller fiber or a laser head with optics of de-magnification. The former may result in less efficient fiber coupling and much larger NA, which may not be acceptable for standard laser heads and systems. The latter may require more expensive laser head optics and will also result in much less working distance. Thus, neither of these conventional techniques will provide BPP improvements enabled by the use of step-core fibers in accordance with embodiments of the invention. The benefits of using step-core fibers, in accordance with embodiments of the invention, as power-delivery fiber are clear, particularly for high-power lasers. (In various embodiments, a “high-power” laser is one capable of producing a beam power of at least 1 kW.) More importantly, these advantages (e.g., improved BPP, reduced spot size, and increased peak intensity) are achieved without decreasing fiber coupling efficiency and without increasing full-power beam size. One small penalty of various embodiments is a few percent increase of the output NA, which is typically acceptable and sometimes may be beneficial.

Step-core optical fibers and laser systems in accordance with embodiments of the invention also have particular relationships for efficient coupling and power delivery. For example, NA₁ may be utilized to represent the inner core NA relative to the outer ring core, NA₀ may be utilized to represent the inner core NA relative to the cladding, and NA₂ may be utilized to represent the outer ring core NA relative to the cladding. In various embodiments of the invention, NA₁ may be greater than or approximately equal to the laser input coupling NA at power content above 50% so that the majority of the power initially coupled into the inner core will be confined within the inner core. (However, in various embodiments, NA₁ may be less than the laser input coupling NA at full-power, such that at least some full-power light is coupled into the outer core. In such embodiments, the portion of laser power coupled outside of the inner core may depend on how much larger the laser input coupling NA is compared to NA₁ and how much larger the focused laser spot size is compared to the inner core diameter.) Moreover, in various embodiments NA₂ is larger than the laser input full-power NA (i.e., the laser-beam NA at a power of approximately 100%) so that no significant power is lost to the cladding due to NA acceptance issues. In various embodiments, because laser powers of 100% may not be practically feasible or advisable, as utilized herein, laser powers of “approximately 100%” or of “full power” or of “approximately full power” refer to laser powers of at least 98% (e.g., 98%-100%), at least 99% (e.g., 99%-100%), or at least 99.5% (e.g., 99.5%-100%).

In addition, in various embodiments, NA₁ is no greater than NA₂. Since NA₁²+NA₂²=NA₀², then NA₁≤NA₀/sqrt(2). For example, if NA₀=0.22, then NA₁≤0.155. For reference, the step-core fiber utilized in the simulations of FIGS. 4A and 4B has an NA₀ of 0.22 and an NA₁ of 0.1, while the laser has effective input NA of around 0.06 and 0.09 at 50% and 87% power contents, respectively. In various embodiments, the step-core fiber features multiple inner cores, and the above-described NA relationships apply to each of the inner cores.

In embodiments in which multiple input beams of different wavelengths are utilized, the above-described NA relationships may apply to one or more of the beams but not all of the beams. For example, for a primary beam having a longer wavelength, NA₁ may be greater than or approximately equal to the laser input coupling NA at power content above 50%, NA₁ may be less than the laser input coupling NA at full-power, and NA₂ may be larger than the laser input full-power NA. Moreover, for a secondary beam having a shorter wavelength coupled into the same step-core fiber, NA₁ (and therefore also NA₂) may be larger than or approximately equal to the laser input coupling NA at full power. In addition, in various embodiments, NA₁ may be approximately equal to or larger than the laser input NA (e.g., at full power) of both the primary beam and the secondary beam. In such embodiments, the power of each laser coupled outside of the inner core (e.g., into the outer core) may primarily depend on the amount that the focused beam spot of each laser is larger than the inner core diameter (e.g., the amount of the beam spot overlapping portions of the fiber outside of the inner core).

While the exemplary step-core optical fibers described above generally have inner and outer cores that are coaxial, i.e., have inner cores having central axes that coincide with the central axes of the optical fiber and the outer core, embodiments of the present invention include step-core fibers having off-center, or decentered, inner cores. In various embodiments, the outer diameter of the inner core intersects (i.e., coincides with), at one or more points, the diameter of the outer core. In other embodiments, the inner core is completely surrounded by the outer core. In such embodiments, the thickness of the outer core disposed between the inner core and the cladding may be at least approximately 1 μm, at least approximately 2 μm, at least approximately 3 μm, or at least approximately 5 μm. In various embodiments, the thickness of the outer core disposed between the inner core and the cladding may be at most approximately 15 μm, at most approximately 12 μm, at most approximately 10 μm, or at most approximately 8 μm. In various embodiments, the diameter of the inner core may range from, for example, approximately 20% to approximately 80% of the outer core diameter, approximately 30% to approximately 70% of the outer core diameter, or approximately 40% to approximately 60% of the outer core diameter. In various embodiments, the displacement of the central axis of the inner core from the central axis of the outer core may be at least 10%, at least 20%, at least 30%, at least 40%, at least 50%, at least 60%, at least 70%, at least 80%, at least 90%, or at least 100% of the diameter of the inner core.

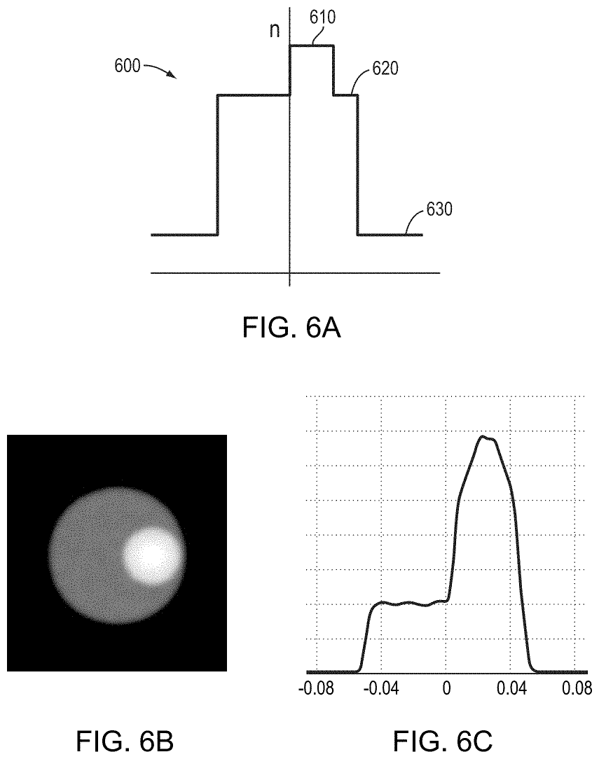

FIG. 6A depicts an example refractive index profile over the diameter of a decentered step-core optical fiber 600 in accordance with embodiments of the invention. As shown, the central axis of the inner core 610 is not coincident with the central axes of the outer core 620 (which is itself surrounded by a cladding 630) or the overall fiber 600. In various embodiments, no portion of the inner core 610 intersects or overlaps with the central axes of the outer core 620 or of the overall optical fiber 600. FIGS. 6B and 6C respectively depict an image of the beam at the fiber exit and a cross-sectional image of the beam at the exit, corresponding to a beam coupled into the decentered step-core fiber of FIG. 6A. As shown, such fibers may advantageously result in tailored beams having “sharp” fronts with significantly higher intensity and “tails” having lower intensity. The images of FIGS. 6B and 6C are results of the same simulations utilized for FIGS. 4A and 4B, but with the inner core being decentered by 20 μm and its diameter set to 40 μm. The resulting beams, as shown in FIGS. 6B and 6C, may be beneficial for some applications and may improve laser process performance. For example, the sharp front having high peak intensity may help reduce laser cutting kerf width, and the lower tail may help expel the debris resulting from the cutting process. Thus, in various embodiments of the invention, a workpiece may be processed (e.g., cut) along a processing path with a beam from a decentered step-core fiber like that shown in FIG. 6C, where the high-intensity “front” peak of the beam is maintained parallel to the processing path (including during, e.g., directional changes) and leads the lower-intensity “tail” of the beam during the processing. For example, the laser head (from which the output beam is emitted) or the workpiece may be rotated during cutting such that the leading edge of the cut is performed by the peak of the beam, while the tail of the beam trails along behind.

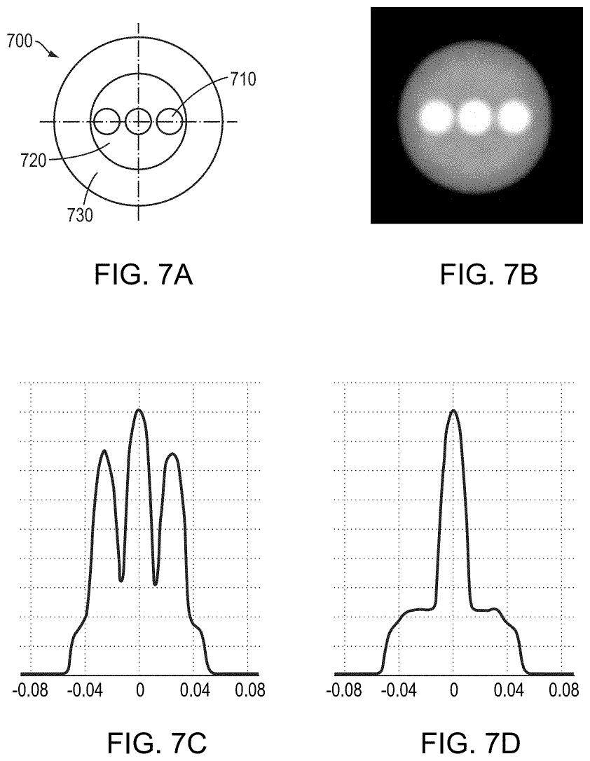

While the exemplary step-core optical fibers described above generally have single inner cores, embodiments of the present invention include step-core optical fibers having multiple inner cores embedded within the outer core region. In such embodiments, the outer core will generally both surround and extend between the various inner cores. FIG. 7A depicts an exemplary step-core optical fiber 700 having multiple inner or center cores 710, in accordance with embodiments of the present invention, surrounded by an outer core 720 and a cladding 730. FIG. 7B is an image of the resulting beam at the fiber exit, and FIGS. 7C and 7D are cross-sectional beam intensity profiles along the horizontal axis (FIG. 7C) and the vertical axis (FIG. 7D) of FIG. 7B. The image of FIG. 7B is a simulation result based on the same numerical example as utilized for FIGS. 4A and 4B, but with three 20 μm inner cores 710 evenly spaced along the central horizontal axis of the fiber, resulting in a series of sharp, intense laser peaks in the beam output. When compared to the control, conventional 100 μm step-index fiber, the peak intensity of the beam emitted from the fiber 700 of FIG. 7A is enhanced by a factor of 2.4.

As mentioned above, inner cores of step-core fibers in accordance with embodiments of the invention generally have higher refractive indices than that of the outer core, but the multiple inner cores need not have the same refractive index (although they can, in accordance with various embodiments). Moreover, the center cores, even in embodiments in which there is only a single center core, need not be circular in cross-sectional shape. Rather, the center cores may have other shapes, and may have shapes different from each other, e.g., rectangular, oval, triangular, etc. In various embodiments in which the step-core fiber features multiple inner cores, the input beam size (or smaller and/or larger dimensions thereof) is generally larger than the diameter, or smaller or larger lateral dimension, of each of the inner cores. That is, in embodiments of the invention, the input beam generally overlaps more than one, or even all, of the inner cores, and does not have a sufficiently small beam size that it may be translated from one inner core to another without overlapping both inner cores. Moreover, in various embodiments, the power of the input beam, and/or its position on the input face, are typically not modulated or varied when the beam is coupled into the step-core optical fiber. In this manner, all of the inner cores, as well as the outer core (at least a portion thereof) may be simultaneously illuminated by the same input beam, and/or even with substantially the same input beam intensity.

In embodiments of the present invention, BPP improvement (or decreased BPP degradation) is achieved without sacrificing fiber-coupling efficiency and stability, at least because the outer core diameter of the step-core fiber is assumed to be equal to the core diameter of a conventional step-index fiber which otherwise would be used. In other words, coupling efficiency and stability may be improved by using step-core fiber having a larger outer core diameter without causing more BPP degradation when compared to the case of using a conventional step-index fiber. In addition, in various embodiments the central axis of the input laser spot may be aimed at the central axis of the outer core in order to maximize coupling efficiency of the beam. In embodiments featuring decentered and/or multiple inner cores, the central axis of the input laser spot may be aimed at the central axis of the, or one of the, inner cores in order to further increase the resulting output intensity emitted from that inner core. In various embodiments, the input laser spot does not overlap the outer cladding layer, and thus substantially no power is lost to the cladding during in-coupling of the input beam.

In various embodiments of the invention, the output end of the step-core optical fiber (i.e., the end of the fiber opposite the input end receiving the beam) may have coupled thereto a laser head for directing the output beam toward a workpiece to be processed. The laser head may include, consist essentially of, or consist of one or more optical elements for focusing and/or collimating the output beam, and/or controlling the polarization and/or the trajectory of the beam. For example, laser heads in accordance with embodiments of the invention may include one or more collimators (i.e., collimating lenses) and/or focusing optics (e.g., one or more focusing lenses). A laser head may not include a collimator if the beam(s) entering the laser head are already collimated. Laser heads in accordance with various embodiments may also include one or more protective window, a focus-adjustment mechanism (manual or automatic, e.g., one or more dials and/or switches and/or selection buttons). Laser heads may also include one or more monitoring systems for, e.g., laser power, target material temperature and/or reflectivity, plasma spectrum, etc. A laser head may also include optical elements for beam shaping and/or adjustment of beam quality (e.g., variable BPP) and may also include control systems for polarization of the beam and/or the trajectory of the focusing spot.

The laser head may be positioned to emit the output beam toward a workpiece and/or toward a platform or positionable gantry on which the workpiece may be disposed. In various embodiments, the laser head includes one or more optical elements for rotating the output beam. Such embodiments may be particularly useful when the output beam is not rotationally symmetric, for example, as shown in FIG. 6C and FIGS. 7C and 7D. Various embodiments of the invention may include laser heads configured to deliver asymmetric and/or rotatable output beams as described in U.S. patent application Ser. No. 17/123,305, filed on Dec. 16, 2020, the entire disclosure of which is incorporated by reference herein. In this manner, output beams that are not rotationally symmetric may be aligned and rotated as desired along processing paths that have directional changes, as also discussed above.

In various embodiments, a computer-based controller may initiate and control processes performed using the output beam (and/or the laser head). For example, the controller may even control the motion of the fiber and/or the laser head relative to the workpiece via control of, e.g., one or more actuators. The controller may also operate a conventional positioning system configured to cause relative movement between the output laser beam and the workpiece being processed. For example, the positioning system may be any controllable optical, mechanical or opto-mechanical system for directing the beam through a processing path along a two- or three-dimensional workpiece. During processing, the controller may operate the positioning system and the laser system so that the laser beam traverses a processing path along the workpiece. The processing path may be provided by a user and stored in an onboard or remote memory, which may also store parameters relating to the type of processing (cutting, welding, etc.) and the beam parameters (e.g., beam shape, intensity, and/or BPP) necessary or desired to carry out that processing. In this regard, a local or remote database may maintain a library of materials and thicknesses that the system will process. The stored values may include beam properties suitable for various processes of the material (e.g., piercing, cutting, etc.), the type of processing, and/or the geometry of the processing path. Moreover, in embodiments featuring multiple input beams, the controller may control the relative power level of each beam, the operation of the beams (e.g., in sequence and/or simultaneously), etc., and such control may be based on one or more properties of the workpiece, sensed parameters or feedback from the workpiece, and/or stored values related to various processes and/or the geometry of the processing path.

As is well understood in the plotting and scanning art, the requisite relative motion between the output beam (and/or the laser head) and the workpiece may be produced by optical deflection of the beam using a movable mirror, physical movement of the laser using a gantry, lead-screw or other arrangement, and/or a mechanical arrangement for moving the workpiece rather than (or in addition to) the beam. The controller may, in some embodiments, receive feedback regarding the position and/or processing efficacy of the beam relative to the workpiece from a feedback unit, which will be connected to suitable monitoring sensors.

Embodiments of the invention may enable a user to process (e.g., cut, drill, or weld) a workpiece along a desired processing path, and the properties of the output beam (e.g., beam shape, BPP, or both), power level of the output beam, and/or maximum processing speed are selected based on factors such as, but not limited to, the composition of the workpiece, the thickness of the workpiece, the geometry of the processing path, etc. For example, a user may select or preprogram the desired processing path and/or type (and/or other properties such as thickness) of the workpiece into the system using any suitable input device or by means of file transfer. Thereafter, the controller may determine optimum processing speeds or output beam power levels as a function of location along the processing path. In operation, the controller may operate the laser system and positioning of the workpiece to process the workpiece along the preprogrammed path, utilizing the proper output beam properties for processes such as cutting or welding. If the composition and/or thickness of the material being processed changes, the location and nature of the change may be programmed, and the controller may adjust the laser beam properties and/or the rate of relative motion between the workpiece and the beam accordingly.

In addition, the laser system may incorporate one or more systems for detecting the thickness of the workpiece and/or heights of features thereon. For example, the laser system may incorporate systems (or components thereof) for interferometric depth measurement of the workpiece, as detailed in U.S. patent application Ser. No. 14/676,070, filed on Apr. 1, 2015, the entire disclosure of which is incorporated by reference herein. Such depth or thickness information may be utilized by the controller to control the output beam properties and/or processing speed to optimize the processing of the workpiece, e.g., in accordance with records in the database corresponding to the type of material being processed.

The controller may be provided as either software, hardware, or some combination thereof. For example, the system may be implemented on one or more conventional server-class computers, such as a PC having a CPU board containing one or more processors such as the Pentium or Celeron family of processors manufactured by Intel Corporation of Santa Clara, Calif., the 680x0 and POWER PC family of processors manufactured by Motorola Corporation of Schaumburg, Ill., and/or the ATHLON line of processors manufactured by Advanced Micro Devices, Inc., of Sunnyvale, Calif. The processor may also include a main memory unit for storing programs and/or data relating to the methods described herein. The memory may include random access memory (RAM), read only memory (ROM), and/or FLASH memory residing on commonly available hardware such as one or more application specific integrated circuits (ASIC), field programmable gate arrays (FPGA), electrically erasable programmable read-only memories (EEPROM), programmable read-only memories (PROM), programmable logic devices (PLD), or read-only memory devices (ROM). In some embodiments, the programs may be provided using external RAM and/or ROM such as optical disks, magnetic disks, as well as other commonly used storage devices. For embodiments in which the functions are provided as one or more software programs, the programs may be written in any of a number of high level languages such as FORTRAN, PASCAL, JAVA, C, C++, C#, BASIC, various scripting languages, and/or HTML. Additionally, the software may be implemented in an assembly language directed to the microprocessor resident on a target computer; for example, the software may be implemented in Intel 80×86 assembly language if it is configured to run on an IBM PC or PC clone. The software may be embodied on an article of manufacture including, but not limited to, a floppy disk, a jump drive, a hard disk, an optical disk, a magnetic tape, a PROM, an EPROM, EEPROM, field-programmable gate array, or CD-ROM.

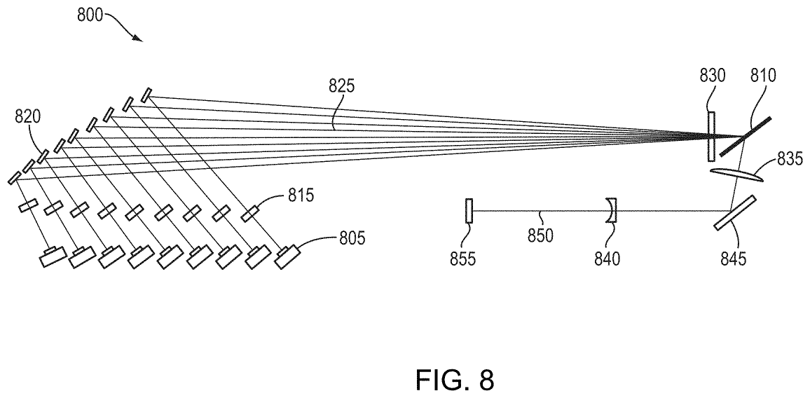

Laser systems and laser delivery systems in accordance with embodiments of the present invention and detailed herein may be utilized in and/or with WBC laser systems. Specifically, in various embodiments of the invention, multi-wavelength output beams of WBC laser systems may be utilized as the input beams for step-core optical fibers and laser beam delivery systems as detailed herein. FIG. 8 schematically depicts various components of a WBC laser system (or “resonator”) 800 that may be utilized to form input beams used in embodiments of the present invention. In the depicted embodiment, resonator 800 combines the beams emitted by nine different diode bars (as utilized herein, “diode bar” refers to any multi-beam emitter, i.e., an emitter from which multiple beams are emitted from a single package). Embodiments of the invention may be utilized with fewer or more than nine emitters. In accordance with embodiments of the invention, each emitter may emit a single beam, or, each of the emitters may emit multiple beams. The view of FIG. 8 is along the WBC dimension, i.e., the dimension in which the beams from the bars are combined. The exemplary resonator 800 features nine diode bars 805, and each diode bar 805 includes, consists essentially of, or consists of an array (e.g., one-dimensional array) of emitters along the WBC dimension. In various embodiments, each emitter of a diode bar 805 emits a non-symmetrical beam having a larger divergence in one direction (known as the “fast axis,” here oriented vertically relative to the WBC dimension) and a smaller divergence in the perpendicular direction (known as the “slow axis,” here along the WBC dimension).

In various embodiments, each of the diode bars 805 is associated with (e.g., attached or otherwise optically coupled to) a fast-axis collimator (FAC)/optical twister microlens assembly that collimates the fast axis of the emitted beams while rotating the fast and slow axes of the beams by 90°, such that the slow axis of each emitted beam is perpendicular to the WBC dimension downstream of the microlens assembly. The microlens assembly also converges the chief rays of the emitters from each diode bar 805 toward a dispersive element 810. Suitable microlens assemblies are described in U.S. Pat. No. 8,553,327, filed on Mar. 7, 2011, and U.S. Pat. No. 9,746,679, filed on Jun. 8, 2015, the entire disclosure of each of which is hereby incorporated by reference herein.

In embodiments of the invention in which both a FAC lens and an optical twister (e.g., as a microlens assembly) are associated with each of the beam emitters and/or emitted beams, and SAC lenses (as detailed below) affect the beams in the non-WBC dimension. In other embodiments, the emitted beams are not rotated, and FAC lenses may be utilized to alter pointing angles in the non-WBC dimension. Thus, it is understood that references to SAC lenses herein generally refer to lenses having power in the non-WBC dimension, and such lenses may include FAC lenses in various embodiments. Thus, in various embodiments, for example embodiments in which emitted beams are not rotated and/or the fast axes of the beams are in the non-WBC dimension, FAC lenses may be utilized as detailed herein for SAC lenses.

As shown in FIG. 8, resonator 800 also features a set of SAC lenses 815, one SAC lens 815 associated with, and receiving beams from, one of the diode bars 805. Each of the SAC lenses 815 collimates the slow axes of the beams emitted from a single diode bar 805. After collimation in the slow axis by the SAC lenses 815, the beams propagate to a set of interleaving mirrors 820, which redirect the beams 825 toward the dispersive element 810. The arrangement of the interleaving mirrors 820 enables the free space between the diode bars 805 to be reduced or minimized. Upstream of the dispersive element 810 (which may include, consist essentially of, or consist of, for example, a diffraction grating such as the transmissive diffraction grating depicted in FIG. 8, or a reflective diffraction grating), a lens 830 may optionally be utilized to collimate the sub-beams (i.e., emitted rays other than the chief rays) from the diode bars 805. In various embodiments, the lens 830 is disposed at an optical distance away from the diode bars 805 that is substantially equal to the focal length of the lens 830. Note that, in typical embodiments, the overlap of the chief rays at the dispersive element 810 is primarily due to the redirection of the interleaving mirrors 820, rather than the focusing power of the lens 830.

Also depicted in FIG. 8 are lenses 835, 840, which form an optical telescope for mitigation of optical cross-talk, as disclosed in U.S. Pat. No. 9,256,073, filed on Mar. 15, 2013, and U.S. Pat. No. 9,268,142, filed on Jun. 23, 2015, the entire disclosure of which is hereby incorporated by reference herein. Resonator 800 may also include one or more optional folding mirrors 845 for redirection of the beams such that the resonator 800 may fit within a smaller physical footprint. The dispersive element 810 combines the beams from the diode bars 805 into a single, multi-wavelength beam 850, which propagates to a partially reflective output coupler 855. The coupler 855 transmits a portion of the beam as the output beam of resonator 800 while reflecting another portion of the beam back to the dispersive element 810 and thence to the diode bars 805 as feedback to stabilize the emission wavelengths of each of the beams.

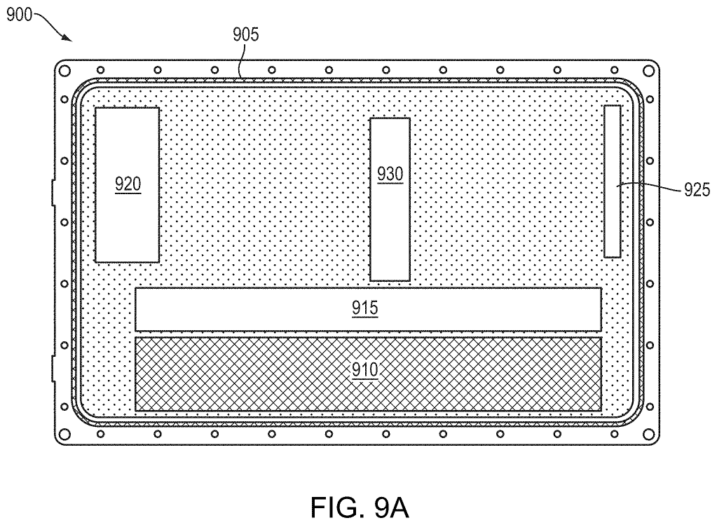

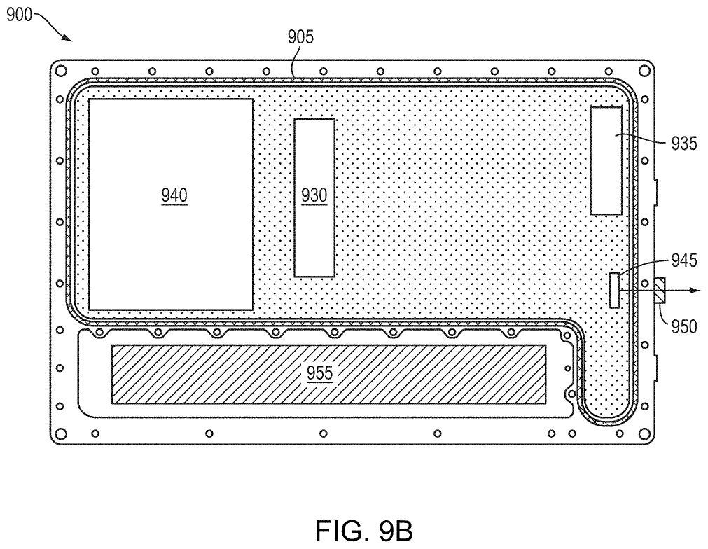

Various embodiments of the invention implement an external cavity laser system and reduce the required size of the resonator using a laser cavity that extends along opposing sides of the resonator. FIGS. 9A and 9B depict opposing sides of a resonator 900 that collectively constitute a single laser cavity (connected by a central opening, as detailed below). In accordance with embodiments of the invention, both sides of resonator 900 may be sealed, e.g., along a sealing path 905. For example, a solid cover plate may be sealed over each side of the resonator 900 along the sealing paths 905 to seal the laser cavity within the resonator 900. In various embodiments, each cover plate may be fastened and/or sealed to resonator 900 via fasteners (e.g., screws, bolts, rivets, etc.) that extend into (and may mechanically engage with, e.g., threadingly engage with) apertures defined in resonator 900. In other embodiments, each cover plate may be sealed along its sealing path 905 via a technique such as welding, brazing, or use of an adhesive material.

In various embodiments, reflectors such as mirrors may be utilized to direct the beams from one or more beam emitters within the laser cavity, and, since the laser cavity extends along both sides, the overall size of the resonator 900 may be correspondingly reduced for the same cavity size (e.g., compared to a resonator having an optical cavity on only one side).

In the exemplary embodiment shown in FIGS. 9A and 9B, beams from beam emitters (e.g., beam emitters 805 shown in FIG. 8) disposed in mounting area 910 may be focused by a group of lenses (and/or other optical elements; for example, SAC lenses 815 shown in FIG. 8) disposed in lens area 915 toward a group of mirrors (e.g., interleaving mirrors 820 shown in FIG. 8) in a mirror area 920. From mirror area 920, the beams from the beam emitters may be directed to another mirror area 925 (containing multiple reflectors such as mirrors) and thence through an opening 930 to the remaining portion of the laser cavity on the other side of resonator 900. As shown in FIG. 9B, the beams may be directed to a mirror area 935 (containing multiple reflectors such as mirrors), which reflects the beams to a beam-combining area 940. In example embodiments, the beam-combining area 940 may include therewithin the diffusive element 810 (and, in some embodiments, the output coupler 845) shown in FIG. 8. In various embodiments, the beams each have a different wavelength, and the beams are combined in beam-combining area 940 into an output beam composed of the multiple wavelengths. The beam from the beam-combining area 940 may be directed to a mirror 945 (which, in various embodiments, may be partially reflective output coupler 845) and thence to an output 950 for emission from the resonator 900. For example, the output may be a window for emission of the beam therethrough or an optical coupler configured to connect directly to an optical fiber such as a step-core optical fiber in accordance with embodiments of the invention. In various embodiments, the output may transmit the beam to a fiber-optic module (see below) for coupling into an optical fiber. In other embodiments, the output beam may be transmitted to a beam-combining module (see below), and combined with output beams emitted by other resonators. The resulting combined beam may be transmitted to a fiber-optic module for coupling into an optical fiber, and/or utilized for processing of a workpiece.

As shown in FIG. 9B, resonator 900 may also include a liquid coolant cavity 955. The liquid coolant cavity 955 is, in various embodiments, a hollow cavity configured to contain liquid coolant (e.g., water, glycol, or other heat-transfer fluid) directly beneath the mounting area 910. The liquid coolant may flow into and out of the cavity 955 via a fluid inlet and a fluid outlet (not shown), which may be fluidly coupled to, e.g., a reservoir of coolant and/or a heat exchanger for cooling fluid heated by the beam emitters. Embodiments of the invention may feature a control system that controls the rate of fluid flow into and out of the cavity 955 based on one or more sensed characteristics, e.g., temperature of the beam emitters, the cooling fluid, and/or one or more other components of and/or positions within resonator 900. In various embodiments, the laser cavity of resonator 900 may be sealed without sealing or covering of the optical coolant cavity 955, thereby leaving the optical coolant cavity 955 accessible (e.g., for service, maintenance, or cleaning) without the need to unseal or expose the more delicate components disposed within the laser cavity.

As mentioned above, in various embodiments of the invention, multiple beams having different wavelengths may be coupled into the step-core fiber to facilitate the processing of various workpieces. For example, embodiments of the invention utilize a secondary, shorter-wavelength laser for initiation of a cutting operation (e.g., piercing) when a material is in the solid state, and, once the material is molten, a primary, longer-wavelength laser is utilized for processes such as cutting of the material. For example, at least in the solid state, the absorption of most metals increases as the laser wavelength decreases. Notably, aluminum has an absorption peak at approximately 810 nm, and metals such as copper, gold, and silver are very reflective and exhibit very low absorption at near-infrared wavelengths and beyond (e.g., at wavelengths of approximately 800 nm or 1000 nm and higher). Thus for many materials (e.g., metallic materials), below the melting point of the material, the absorption is significantly higher for the shorter-wavelength light. However, when the melting point is reached and the surface begins to melt, the absorption increases significantly and becomes substantially independent of wavelength. The absorption continues to increase as the temperature increases to the vaporization temperature (e.g., the regime where cutting is performed), whereupon the absorption tends to level off at a significant level. Thus, embodiments of the invention utilize the secondary, shorter-wavelength beam for initiation of a cutting operation (e.g., piercing) when the material is in the solid state, and, once the material is molten, the primary, longer-wavelength beam is utilized for processes such as cutting of the material. In other examples, other materials, e.g., plastic, glass, or polymeric materials, may exhibit the opposite behavior, and thus for such materials, embodiments of the invention may utilize the primary, longer-wavelength laser for initiation of a cutting operation (e.g., piercing) when the material is in the solid state, and, once the material is molten, the secondary, shorter-wavelength laser is utilized for processes such as cutting of the material.

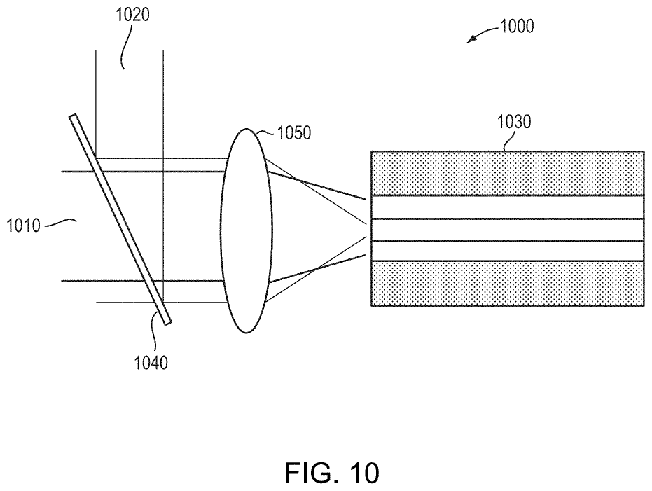

FIG. 10 schematically depicts various components of a laser system 1000 in accordance with embodiments of the present invention. As shown, in the laser system 1000 the primary beam 1010 from a primary laser and the secondary beam 1020 from a secondary laser are both coupled (or couplable) into a step-core optical fiber 1030 utilizing one or more optical elements. In the specific depicted embodiment, a dichroic mirror 1040 is utilized to redirect the secondary beam 1020 to the focusing optics 1050 that couple the beam into the fiber 1030, while the dichroic mirror 1040 allows the primary beam 1010 to pass through the mirror to the focusing optics 1050. As shown, in various embodiments, the primary and secondary beams are coupled or couplable substantially coaxially into the step-core optical fiber 1030. In various embodiments, the step-core optical fiber 1030 may include, consist essentially of, or consist of any of the fibers 200, 600, 700 detailed herein.

As shown in FIG. 10, in various embodiments the focusing lens 1050 utilized to couple the beams into the step-core optical fiber 1030 focuses the secondary, shorter wavelength, beam 1020 to a smaller input spot size than the resulting spot size for the primary beam 1010. Assuming that the primary and secondary beams have M² values that are approximately the same, the focused spot diameter d of each beam, focused by the focusing lens, is proportional to the wavelength λ of the beam, and may be calculated by d=2×M²/NA×λ/π, where the laser coupling NA is given by NA=D/2/f, with D referring to the full beam size at the focusing lens and f being the focal length of the focusing lens. Thus, in various embodiments, the secondary, shorter wavelength beam 1020 will have a smaller input spot size than that of the primary beam 1010 when both beams are focused into the step-core optical fiber 1030 by the same focusing lens 1050. In addition, the spot size of either beam may be further adjusted by adjusting the laser input NA of the beam upstream of the focusing lens 1050. For example, increasing the laser input NA by expanding the beam size (e.g., using optical elements such as an optical telescope, e.g., a Galilean telescope) upstream of the focusing lens 1050 decreases the focused spot size of the beam. (Reversing the telescope may decrease the beam size and the laser input NA upstream of the lens, increasing the focused spot size of the beam.)

Thus, in various embodiments, the primary beam 1010 may overlap both the inner core and the outer, annular core, while the secondary beam 1020 overlaps only the inner core. Advantageously, the same focusing lens 1050 may be utilized for both beams while minimizing or reducing BPP degradation of the primary beam 1010. In addition, in various embodiments, the secondary laser may have less emission power than the primary laser. In such embodiments, coupling the secondary laser beam 1020 into only the inner core will maximize the intensity enhancement of the secondary laser beam 1020, which is advantageous for many applications, e.g., during piercing processes. In other embodiments, both the primary beam 1010 and the secondary beam 1020 have focused spot sizes that only overlap the inner core, and most or substantially all of the laser power thereof is coupled into the inner core. In such embodiments, the step-core optical fiber 1030 provides beneficial effects to both beams, as described herein, including improved BPP, reduced effective spot size, and enhanced peak power.

In various embodiments, one or both of the beams may be non-circular. For example, the primary beam 1010 may be non-circular, while the secondary beam 1020 is circular, or both beams may be non-circular. Therefore, in various embodiments, approximately 100% of the power of the secondary beam 1020 is coupled into the inner core (e.g., even when the secondary beam source operates at full power), while most of the power of the primary beam 1010 is coupled into the inner core while some portion of the primary beam is coupled into the outer core (e.g., as detailed above related to FIGS. 3C and 3D).

As mentioned previously, in various embodiments, the primary laser emits a laser beam 1010 having a longer wavelength (or range of wavelengths) than the laser beam 1020 emitted by the secondary laser. In various embodiments, the primary laser is less expensive, less expensive to operate, and/or more widely available. The primary laser may also be configured to operate at a higher maximum power than the secondary laser. In various embodiments, the secondary laser may be less efficient, have a shorter lifetime, and be more costly (e.g., in terms of cost per output power).

In various embodiments, the primary and secondary lasers are different types of lasers. For example, the primary laser may include, consist essentially of, or consist of a direct-diode laser (e.g., emitting in free space or coupled into an optical fiber), a fiber laser, or a solid-state laser (i.e., a laser utilizing a solid gain medium such as a glass or crystal doped with one or more rare-earth elements). In various embodiments, the secondary laser may include, consist essentially of, or consist of a direct-diode laser (e.g., emitting in free space or coupled into an optical fiber), a gas laser, or a solid-state laser. In various embodiments, direct-diode WBC lasers may be preferred for the primary laser and/or the secondary laser due to their capability to process materials (e.g., metallic materials) with higher quality. Without wishing to be bound by theory, WBC lasers may provide better quality due to their broadband nature resulting from the combination of tens (or even hundreds) of discrete emitters each having a different wavelength—this may scramble laser coherence and speckle while smoothing the laser intensity profile in both the spatial domain and the time domain.

Thus, as detailed herein, either or both of the primary laser and secondary laser may emit multi-wavelength beams. In accordance with embodiments of the invention, the “wavelength” or “primary wavelength” of such a multi-wavelength beam may correspond to the central (i.e., middle) and/or most intense wavelength emitted by the laser. As known to those of skill in the art, virtually all laser outputs include a band of multiple wavelengths, although laser wavelength bands tend to be quite narrow. For example, a fiber laser emitting at 1064 nm may have a very narrow band of about 2 nm, while a WBC direct-diode laser emitting at 970 nm may have a band of about 40 nm.

In various embodiments, the primary laser beam 1010 has a wavelength (or range of wavelengths) ranging from approximately 780 nm to approximately 11 μm, from approximately 780 nm to approximately 1064 nm, from approximately 780 nm to approximately 1000 nm, approximately 870 nm to approximately 11 μm, from approximately 870 nm to approximately 1064 nm, or from approximately 870 nm to approximately 1000 nm. In particular embodiments, the wavelength (or primary or center wavelength) of the primary laser beam 1010 may be, for example, approximately 1064 nm, approximately 10.6 μm, approximately 970 nm, approximately 780 or 850 to approximately 1060 nm, or approximately 950 nm to approximately 1070 nm. In various embodiments, the secondary laser beam 1020 has a wavelength (or range of wavelengths) ranging from approximately 300 nm to approximately 740 nm, approximately 400 nm to approximately 740 nm, approximately 530 nm to approximately 740 nm, approximately 300 nm to approximately 810 nm, approximately 400 nm to approximately 810 nm, or approximately 530 nm to approximately 810 nm. In various embodiments, the wavelength of the secondary laser beam 1020 is in the UV or visible range, although the wavelength may extend up to approximately 810 nm for materials (e.g., aluminum) having absorption peaks in that range. In particular embodiments, the wavelength (or primary or center wavelength) of the secondary laser beam 1020 may be, for example, approximately 810 nm, approximately 400-approximately 460 nm, or approximately 532 nm. In various embodiments, the primary laser source and/or the secondary laser source is a WBC laser emitting a broadband, multi-wavelength laser beam. In various embodiments, such lasers may have bandwidths ranging from, for example, approximately 10 nm to approximately 60 nm.

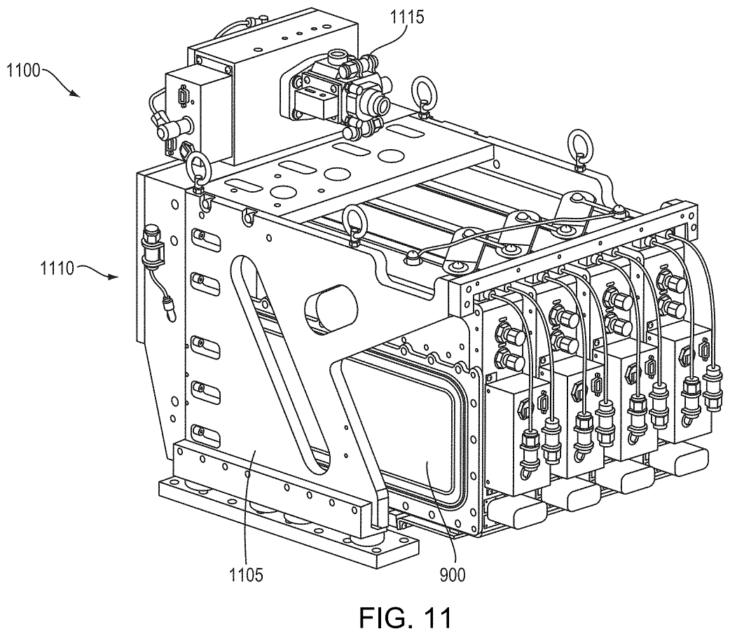

Thus, in various embodiments, a laser system incorporates multiple resonators 900, and the output beams from the resonators 900 are combined downstream (e.g., within a master housing and/or by one or more optical elements, as shown in FIG. 10) into a single output beam that may be coupled into a step-core optical fiber and then directed to a workpiece for processing (e.g., welding, cutting, annealing, etc.). For example, FIG. 11 depicts an exemplary laser system (or “laser engine”) 1100 in accordance with embodiments of the invention. In laser system 1100, multiple laser resonators 900 are mounted within a master housing 1105, and the output beams from the resonators 900 are emitted into a beam-combining module 1110 and thence to a fiber optic module 1115. In exemplary embodiments, beam-combining module 1110 may contain one or more optical elements, such as mirrors, dichroic mirrors, lenses, prisms, dispersive elements, polarization beam combiners, etc., that may combine beams received from the various resonators into one or more output beams (for example, as shown in FIG. 10). In various embodiments, the fiber-optic module 1115 may contain, for example, one or more optical elements for adjusting output laser beams, as well as interface hardware connecting to the optical fiber for coupling of the beams therein. For example, the fiber-optic module 1115 may include some or all of the components depicted in FIG. 10 utilized to couple beam energy into fiber 1030. While laser engine 1100 is depicted as including four resonators 900, laser engines in accordance with embodiments of the invention may include one, two, three, or five or more laser resonators. Each resonator may emit a beam having a different wavelength (or a different range of wavelengths), and these beams may be combined and coupled in the fiber as detailed herein.

Although example embodiments detailed herein utilize and describe separate primary and secondary lasers for emission of the primary and secondary laser beams, in various embodiments the primary and secondary laser beams may be generated using the same laser source. For example, a laser source configured to emit a primary laser beam having a longer wavelength may be utilized to also generate the secondary laser beam having a shorter wavelength via frequency doubling (i.e., second harmonic generation (SHG)). In various embodiments, the primary laser beam may be coupled into the step-core optical fiber as detailed herein, and it may also be directed through a nonlinear optical material, which generates SHG radiation having a wavelength approximately one-half of that of the primary laser beam, to thereby generate the secondary laser beam. (While such embodiments have the advantage of requiring only a single laser source, since they utilize SHG such embodiments are restricted to having the wavelength of one laser beam be approximately one-half that of the other laser beam.) In various embodiments, the primary laser beam and secondary laser beam generated therefrom may be substantially collinear, and the secondary laser beam may have a focused spot size approximately one-half that of the primary laser beam, assuming focusing of both beams by the same focusing lens (as detailed above).

In various embodiments, the nonlinear optical material may be moved into and out of the beam path of the primary laser beam as needed for the generation of the secondary laser beam, and/or the laser beam not currently needed for processing (if any, see below) may be directed away from the optical fiber using optical elements such as beam splitters or dichroic mirrors. In various embodiments, laser systems may include mechanisms for orienting the nonlinear optical crystal (e.g., a movable and/or rotatable mount) and/or for controlling its temperature (e.g., a heater or furnace) to, e.g., increase conversion efficiency and/or prevent absorption of moisture.

In various embodiments, an unconverted portion of the primary laser beam traverses the nonlinear optical material during generation of the secondary laser beam, and both laser beams may be coupled into the step-core optical fiber directly from the nonlinear optical material and focusing optics. Thus, in various embodiments, the dichroic mirror shown in FIG. 10 may not be present, and both beams may enter the focusing lens 1050 (substantially collinearly) from the nonlinear optical material. In a non-limiting example, the laser source may be a YAG or fiber laser emitting a laser beam 305 at approximately 1064 nm, which generates a SHG laser beam 315 having a wavelength of approximately 532 nm.

In various embodiments, the nonlinear optical material may include, consist essentially of, or consist of one or more borate crystals such as β-barium borate (β-BaB₂O₄, or BBO), lithium triborate (LiB₃O₅, or LBO), cesium lithium borate (CLBO, CsLiB₆O₁₀), bismuth triborate (BiB₃O₆, or MO), or cesium borate (CsB₃O₅, or CBO). Other exemplary nonlinear optical crystals include potassium fluoroboratoberyllate (KBe₂BO₃F₂, or KBBF), lithium tetraborate (Li₂B₄O₇, or LB₄), lithium rubidium tetraborate (LiRbB₄O₇, or LRB₄), and magnesium barium fluoride (MgBaF₄). Suitable nonlinear optical materials are available commercially and may be provided by one of skill in the art without undue experimentation.

The various wavelengths or wavelength ranges for the primary and secondary beams may be utilized for the processing of various types of workpieces, and in particular workpieces including, consisting essentially of, or consisting of one or more metallic materials. In other embodiments, the wavelengths or wavelength ranges of the “primary” and “secondary” beams may be switched for other types of workpieces, as detailed herein, for example for the processing of workpieces including, consisting essentially of, or consisting of glass, plastic, paper, or one or more polymeric or other non-metallic materials.

The table below summarizes various different combinations of primary and secondary lasers, as well as example metallic target materials (i.e., materials to be processed) for each combination. (In the table, SHG is second harmonic generation.)

| | Primary | Secondary | Example Target |
|---|---|---|---|
| | Laser | Laser | Materials |
| 1 | WBC DDL at | WBC DDL at | Al, Steel, Fe |
| | 870-1000 nm | 810 nm | |
| 2 | WBC DDL at | WBC DDL at | Cu, Ag, Au, Steel, |
| | 870-1000 nm | 400-460 nm | Fe, Mo, Al |
| 3 | WBC DDL at | SHG of Nd: | Cu, Au, Steel, Fe, |
| | 870-1000 nm | YAG laser at | Mo, Al |
| | | 532 nm | |
| 4 | Fiber Laser | WBC DDL at | Cu, Ag, Au, Steel, |
| | at 1064 nm | 400-460 nm | Fe, Mo, Al |
| 5 | Fiber Laser or | CO Laser at | Glass, Paper, |
| | DDL at NIR | 5 μm, CO₂ Laser | Plastic |
| | (e.g., | at 10.6 μm, or | |
| | 750-2500 nm) | Quantum Cascade | |
| | | Laser at 3-11 μm | |

In various embodiments, one or more (or even all) of the primary beam (and/or the primary beam source), the secondary beam (and/or the secondary beam source), the step-core fiber, and/or optical elements utilized to direct the beams and in-couple them into the fiber, are responsive to a computer-based controller. For example, the controller may initiate processes performed using the step-core fiber (and, in various embodiments, a laser head coupled to the output end thereof) and switch on/off (and/or modulate the output power level of) the primary beam and secondary laser beam accordingly. In various embodiments, the controller may even control the motion of the laser head and/or step-core fiber relative to the workpiece via control of, e.g., one or more actuators. The controller may also operate a conventional positioning system configured to cause relative movement between the output laser beam and the workpiece being processed.

As is well understood in the plotting and scanning art, the requisite relative motion between the output beam and the workpiece may be produced by optical deflection of the beam using a movable mirror, physical movement of the laser using a gantry, lead-screw or other arrangement, and/or a mechanical arrangement for moving the workpiece rather than (or in addition to) the beam. The controller may, in some embodiments, receive feedback regarding the position and/or processing efficacy of the beam relative to the workpiece from a feedback unit, which will be connected to suitable monitoring sensors.

In various embodiments, the controller controls the on/off switching and/or the output power level of the primary beam and secondary beam based on sensed information related to the workpiece (e.g., its surface). For example, the laser system may incorporate one or more optical and/or temperature sensors that detect when at least a portion of the surface of the workpiece is molten (via, e.g., a reflectivity change and/or the temperature reaching the melting point of the material; such sensors are conventional and may be provided without undue experimentation). In various embodiments, the secondary beam is utilized to heat the workpiece surface until at least a portion of the surface of the workpiece is molten, or even to pierce through at least a portion of the thickness of the workpiece, and then the primary beam is utilized to cut the workpiece along a processing path originating from the at least partially molten area. In other embodiments, the controller merely switches from the secondary beam to the primary beam after a timed delay, the duration of which may be estimated based on factors such as the type of material, the thickness of the material, the spot size of the output beam, etc.

In various embodiments, both the primary laser beam and the secondary beam are utilized for both piercing and cutting, and therefore both coupled into the step-core fiber simultaneously during both operations, but the power of the primary beam is increased for cutting (and, thus, relatively decreased for piercing) and the power of the secondary beam is increased for piercing (and, thus, relatively decreased for cutting). Such dual-beam embodiments may provide the advantage of higher quality cuts and piercings, due to the broader spectral band of the combined output beam, which significantly decreases laser coherence and speckle. In some embodiments, the primary beam is not utilized until at least a portion of the workpiece surface is rendered molten by the secondary beam, and then both beams are utilized for the subsequent cut. Such embodiments will prevent or significantly reduce deleterious back reflections from the workpiece surface that might damage components (e.g., optical elements) of the laser system.

Embodiments of the invention may enable a user to process (e.g., cut or weld) a workpiece along a desired processing path, and the composition of the output beam (e.g., whether including the primary beam, the secondary beam, or both), power level of the output beam (and/or of the primary beam and/or the secondary beam), and maximum processing speed is selected based on factors such as, but not limited to, the composition of the workpiece, the thickness of the workpiece, the geometry of the processing path, etc. For example, a user may select or preprogram the desired processing path and/or type (and/or other properties such as thickness) of the workpiece into the system using any suitable input device or by means of file transfer. Thereafter, the controller may determine optimum output beam composition (e.g., switching between the primary and secondary beams, and/or their relative power levels) as a function of location along the processing path. In operation, the controller may operate the laser system and positioning of the workpiece to process the workpiece along the preprogrammed path, utilizing the proper output beam compositions for processes such as piercing and cutting. If the composition and/or thickness of the material being processed changes, the location and nature of the change may be programmed, and the controller may adjust the laser beam composition and/or the rate of relative motion between the workpiece and the beam accordingly.

In addition, the laser system may incorporate one or more systems for detecting the thickness of the workpiece and/or heights of features thereon. For example, the laser system may incorporate systems (or components thereof) for interferometric depth measurement of the workpiece, as detailed in U.S. patent application Ser. No. 14/676,070, filed on Apr. 1, 2015, the entire disclosure of which is incorporated by reference herein. Such depth or thickness information may be utilized by the controller to control the output beam composition to optimize the processing (e.g., cutting or piercing) of the workpiece, e.g., in accordance with records in the database corresponding to the type of material being processed.

The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed.

1. A method of processing a workpiece with a laser beam, the method comprising:
providing a step-core optical fiber having an input end and an output end opposite the input end, wherein the step-core optical fiber comprises (i) an inner core having a first refractive index, (ii) surrounding the inner core, an outer core having a second refractive index smaller than the first refractive index, (iii) surrounding the outer core, a cladding having a third refractive index smaller than the second refractive index, (iv) a first inner core numerical aperture (NA) relative to the cladding, (v) a second inner core NA relative to the outer core, and (vi) an outer core NA relative to the cladding;
disposing a workpiece proximate the output end of the optical fiber;
directing into the input end of the optical fiber a variable-power laser beam having a laser-beam NA that varies as a function of the power of the laser beam, to thereby generate an output beam emitted from the output end of the optical fiber, wherein (i) the outer core NA is greater than or equal to the laser-beam NA at a power of approximately 100%, (ii) the second inner core NA is less than or equal to the outer core NA, and (iii) the second inner core NA is greater than or equal to the laser-beam NA at a power of 50%; and
processing the workpiece with the output beam.

2. The method of claim 1, wherein the workpiece is processed along a processing path extending across at least a portion of the workpiece.

3. The method of claim 1, wherein processing the workpiece comprises physically altering at least a portion of a surface of the workpiece.

4. The method of claim 1, wherein processing the workpiece comprises at least one of cutting, welding, etching, annealing, drilling, soldering, or brazing.

5. The method of claim 1, wherein the laser beam generates a non-circular spot on the input end of the optical fiber.

6. The method of claim 5, wherein the spot is elliptical or rectangular.

7. The method of claim 5, wherein the spot has first and second lateral dimensions that are different from each other and perpendicular to each other, the first lateral dimension being larger than the second lateral dimension.

8. The method of claim 7, wherein a diameter of the outer core is larger than the first lateral dimension of the spot.

9. The method of claim 7, wherein a diameter of the inner core is larger than the second lateral dimension of the spot.

10. The method of claim 7, wherein a diameter of the inner core is smaller than the first lateral dimension of the spot.

11. The method of claim 7, wherein a diameter of the inner core is smaller than the second lateral dimension of the spot.

12. The method of claim 1, wherein a cross-sectional shape of the inner core is non-circular.

13. The method of claim 1, wherein a central axis of the inner core is not coaxial with a central axis of the outer core.

14. The method of claim 1, wherein the laser beam generates a spot on the input end of the optical fiber, the spot being larger than a diameter of the inner core and smaller than a diameter of the outer core.

15. The method of claim 1, further comprising emitting the laser beam from a beam emitter comprising:
one or more beam sources emitting a plurality of discrete beams;
focusing optics for focusing the plurality of beams toward a dispersive element;
the dispersive element for receiving and dispersing the received focused beams; and
a partially reflective output coupler positioned to receive the dispersed beams, transmit a portion of the dispersed beams therethrough as the laser beam, and reflect a second portion of the dispersed beams back toward the dispersive element,
wherein the laser beam is composed of multiple wavelengths.

16. The method of claim 15, wherein the dispersive element comprises a diffraction grating.

17. The method of claim 1, wherein the output end of the optical fiber is coupled to a laser head containing one or more optical elements therein.

18. The method of claim 17, further comprising, before and/or during processing of the workpiece with the output beam, rotating the beam using the laser head.

19.-66. (canceled)
